(19) United States
(12) Patent Application Publication
(10) Pub. No.: US 2026/0211482 A1
(43) Pub. Date: Jul. 23, 2026

(54) OCCUPATIONAL STRESS MANAGEMENT USING DIGITAL HUMANS AND HUMAN-COMPUTER INTERACTIONS

(71) Applicant: International Business Machines Corporation, Armonk, NY (US)

(72) Inventors: Ranjan SHARMA, Kolkata (IN); Kanchan Kumar TEWARY, KOLKATA (IN); Sohom ROY, Kolkata (IN)

(21) Appl. No.: 19/032,053

(22) Filed: Jan. 18, 2025

(51) Int. Cl. G06F 3/01

(52) U.S. Cl. CPC G06F 3/011; G06F 2203/011

(57) ABSTRACT

In some embodiments, a computer system includes a processor set, computer-readable storage media, and program instructions to perform operations comprising: generating a digital human corresponding to a user of computing devices, the digital human comprising a machine learning component corresponding to a user stress profile; receiving a first dataset of user interactions from monitoring components; training the machine learning component on the first dataset to output predicted stress measurements based on human-computer interaction (HCl) data from user involvement in a software development project; receiving a second dataset of deployment parameter values; determining a predicted stress measurement value based on the machine learning model and deployment parameter values; and outputting stress content indicative of the predicted stress measurement to a mitigation component. The system may determine stress parameters based on data availability and use a stress weight generator engine to determine stress parameter weights.

### BACKGROUND

The present invention relates to facilitating processing within a computing environment, and for example, relates to occupational stress management using digital humans and human-computer interactions.

### SUMMARY

In one embodiment, a computer system is provided. In this embodiment, the computer system includes a processor set, one or more computer-readable storage media, and program instructions stored on the one or more computer-readable storage media to cause the processor set to perform operations. The operations include generating a digital human corresponding to a user of a set of computing devices, wherein the digital human comprises a machine learning component corresponding to a stress profile associated with the user. The operations further include receiving, from at least one monitoring component associated with at least one of the set of computing devices or the user, a first dataset associated with one or more user interactions with the set of computing devices. The operations also include training the machine learning component based on the first dataset, wherein the machine learning component is trained to output, based on human computer interaction (HCl) data corresponding to an involvement of the user in a software development project, a predicted stress measurement value associated with the user. Additionally, the operations include receiving, from one or more monitoring components of the at least one monitoring component, a second data set comprising a deployment set of parameter values of a set of corresponding stress parameters. The operations further include determining, based on the machine learning model and the deployment set of parameter values, the predicted stress measurement value. Finally, the operations include outputting, to a mitigation component, stress content indicative of the predicted stress measurement value.

In another embodiment, a computer-implemented method is provided. In this embodiment, the method includes generating a digital human corresponding to a user of a set of computing devices, wherein the digital human comprises a machine learning component corresponding to a stress profile associated with the user. The method further includes receiving, from at least one monitoring component associated with at least one of the set of computing devices or the user, a first dataset associated with one or more user interactions with the set of computing devices. The method also includes training the machine learning component based on the first dataset, wherein the machine learning component is trained to output, based on HCl data corresponding to an involvement of the user in a software development project, a predicted stress measurement value associated with the user. Additionally, the method includes receiving, from one or more monitoring components of the at least one monitoring component, a second dataset comprising a deployment set of parameter values of a set of corresponding stress parameters. The method further includes determining, based on the machine learning model and the deployment set of HCl data, the predicted stress measurement value. Finally, the method includes outputting, to a mitigation component, stress content indicative of the predicted stress measurement value.

In yet another embodiment, a computer program product is provided. In this embodiment, the computer program product includes one or more computer-readable storage media and program instructions stored on the one or more computer-readable storage media to perform operations. The operations include generating a digital human corresponding to a user of a set of computing devices, wherein the digital human comprises a machine learning component corresponding to a stress profile associated with the user. The operations further include receiving, from at least one monitoring component associated with at least one of the set of computing devices or the user, a first dataset associated with one or more user interactions with the set of computing devices. The operations also include training the machine learning component based on the first dataset, wherein the machine learning component is trained to output, based on HCl data corresponding to an involvement of the user in a software development project, a predicted stress measurement value associated with the user. Additionally, the operations include receiving, from one or more monitoring components of the at least one monitoring component, a second dataset comprising a deployment set of parameter values of a set of corresponding stress parameters. The operations further include determining, based on the machine learning model and the deployment set of HCl data, the predicted stress measurement value. Finally, the operations include outputting, to a mitigation component, stress content indicative of the predicted stress measurement value.

### BRIEF DESCRIPTION OF THE DRAWINGS

FIG. 1 illustrates a computing environment for monitoring and managing stress levels in software development.

FIG. 2 is a block diagram of an example of a stress management system.

FIGS. 3A and 3B present flowcharts of processes for creating and using a digital human model for stress monitoring.

FIG. 3C depicts a block schematic diagram of a data processing system for generating training and testing data.

FIG. 4A illustrates a flowchart of a process for training and evaluating a machine learning model for stress measurement.

FIG. 4B shows a flowchart of a process for managing occupational stress using digital human models.

FIG. 5 is a diagram of an example computing environment in which systems and/or methods described herein may be implemented.

FIG. 6 is a diagram of example components of one or more devices of FIG. 1.

FIG. 7 is a flowchart of an example process associated with determining and managing occupational stress.

### DETAILED DESCRIPTION

The following detailed description of example implementations refers to the accompanying drawings. The same reference numbers in different drawings may identify the same or similar elements.

The impact of occupational stress levels on the mental health of team members engaged in Software Delivery projects is a matter of considerable importance, particularly within the realm of technological advancements. As projects grow in complexity and timelines tighten, developers often find themselves under significant pressure, which can lead to burnout, decreased productivity, and compromised mental health. Traditional methods of stress monitoring, such as periodic surveys or wearable devices, have proven inadequate in capturing the nuanced and dynamic nature of stress in software development environments. These approaches often fail to provide real-time, context-aware insights into an individual's stress levels, making it difficult for organizations to implement timely and effective interventions.

The challenge is further compounded by the highly individualized nature of stress responses. What causes stress for one developer may not affect another in the same way, and stress levels can fluctuate dramatically based on project phases, roles, and personal factors. Current stress management systems struggle to account for these individual differences, often relying on one-size-fits-all approaches that fail to provide personalized and actionable insights. Additionally, the invasive nature of some stress monitoring techniques, such as wearable devices, can themselves become a source of stress or discomfort for users, potentially skewing the very data they aim to collect.

Another challenge lies in the integration of stress monitoring and management systems with existing software development workflows. Many current solutions require developers to engage in additional tasks or use separate tools for stress tracking, which can disrupt their work and potentially increase rather than alleviate stress. The lack of seamless integration makes it difficult for project managers and team leads to correlate stress levels with specific project activities, phases, or roles, hindering their ability to make informed decisions about workload distribution and project planning.

Furthermore, the sensitive nature of stress-related data raises concerns about privacy and data security. Organizations must balance the need for comprehensive stress monitoring with the ethical considerations of collecting and analyzing personal health information. This challenge is particularly acute in software development environments where data privacy is often a paramount concern, creating a potential conflict between the desire to support employee well-being and the need to protect individual privacy rights.

Human-computer interaction (HCl) data presents a promising avenue for non-invasive stress monitoring, but harnessing this data effectively for stress management in software development contexts remains a significant challenge. Current systems often lack the sophistication to interpret HCl data in a way that accurately reflects an individual's stress levels, especially when considering the complex and varied nature of software development tasks. The ability to create accurate, personalized digital representations of individuals based on their HCl patterns, and to use these representations for proactive stress management, represents a frontier in occupational health that has yet to be fully realized.

Implementations of this disclosure may address problems such as these by providing machine learning (ML) models designed to measure stress and extract relevant data rely on advanced techniques to analyze diverse inputs from physiological, behavioral, or contextual sources. These models process biological signals such as heart rate variability, galvanic skin response, or cortisol levels, often collected via wearable devices. The models may analyze behavioral cues like facial expressions, voice tone, or posture, using computer vision and natural language processing (NLP) algorithms. Contextual data, such as work environment, social interactions, or time-based patterns, is integrated to provide a comprehensive understanding of stress triggers. ML algorithms such as deep learning and clustering methods, identify hidden patterns in the data to classify stress levels or predict stress-related trends. These insights enable applications in healthcare, workplace management, and personal wellness, providing actionable feedback to mitigate stress effectively.

Some implementations include generating a digital human corresponding to a user of computing devices, where the digital human comprises a machine learning component corresponding to a stress profile associated with the user; receiving a first dataset associated with user interactions with the computing devices; training the machine learning component based on the first dataset to output a predicted stress measurement value; receiving a deployment set of HCl data; determining the predicted stress measurement value based on the machine learning model and the deployment set of HCl data; and outputting stress content indicative of the predicted stress measurement value to a mitigation component.

The digital human may represent a virtual model of the user that captures their unique stress characteristics and responses. For example, the digital human may include data on the user's typical keystroke patterns, mouse movements, and voice tone during both stressed and non-stressed states. In some implementations, the digital human may be visualized as an avatar that mimics the user's behaviors. Some implementations may represent the digital human as a set of data points or a mathematical model without a visual component.

The machine learning component of the digital human may be trained on HCl data to recognize patterns indicative of stress. As used herein, “HCl data” refers to any data generated from a user's interactions with computing devices, including but not limited to keystroke dynamics, mouse movements, voice analysis, and facial expressions captured by cameras. For instance, rapid, erratic mouse movements or increased typing errors may indicate elevated stress levels. The machine learning component may utilize various algorithms such as neural networks, decision trees, or support vector machines to analyze this data. In some implementations, the machine learning component may also incorporate data from biological monitoring devices like heart rate monitors or skin conductance sensors to improve accuracy.

The mitigation component may receive the stress content and generate a mitigation plan tailored to the user's needs. This plan may include recommended actions, updated role assignments, scheduling health checkups, team well-being initiatives, or suggestions for time off. For example, if the system detects consistently high stress levels during certain project phases, it may recommend redistributing tasks or providing additional support during those periods. The efficacy of these mitigation strategies may be monitored and used to fine-tune the machine learning component, creating a feedback loop for continuous improvement. In some implementations, the mitigation component may interface with project management software to automatically adjust deadlines or workloads based on detected stress levels across the team.

In some implementations, the system generates a digital human corresponding to a user of computing devices, where the digital human comprises a machine learning component corresponding to a stress profile associated with the user. Accordingly, an advantage of the digital human generation is that it allows for personalized stress monitoring tailored to each individual user's unique characteristics and baseline stress levels. Additionally, an advantage of the digital human generation is that it enables the system to adapt and refine its stress predictions over time as more data is collected, improving accuracy for each specific user.

In some implementations, the system determines a set of stress parameter weights using a stress weight generator engine based on historical and current parameter values associated with the user. Accordingly, an advantage of the stress parameter weight determination is that it allows the system to prioritize the most relevant stress indicators for each individual user, improving the accuracy of stress predictions. Additionally, an advantage of the stress parameter weight determination is that it enables the system to adapt to changes in a user's stress response patterns over time, maintaining relevance and effectiveness throughout a user's career.

In some implementations, the system outputs stress content indicative of the predicted stress measurement value to a mitigation component, which can generate and implement a mitigation plan. Accordingly, an advantage of the stress content output and mitigation plan generation is that it provides actionable insights and recommendations for reducing stress levels, potentially improving employee well-being and productivity. Additionally, an advantage of the stress content output and mitigation plan generation is that it allows for proactive stress management, enabling interventions before stress levels become problematic and potentially reducing burnout and turnover in software development teams. In some examples, the devices (used to measure stress) may only be used one-time for calibration of the parameter weightage and stress levels. Implementations described herein may be directed to measurement of changes in stress levels rather than the absolute value of the stress itself. The digital human may be created because stress and stress coping mechanisms are very specific to each individual.

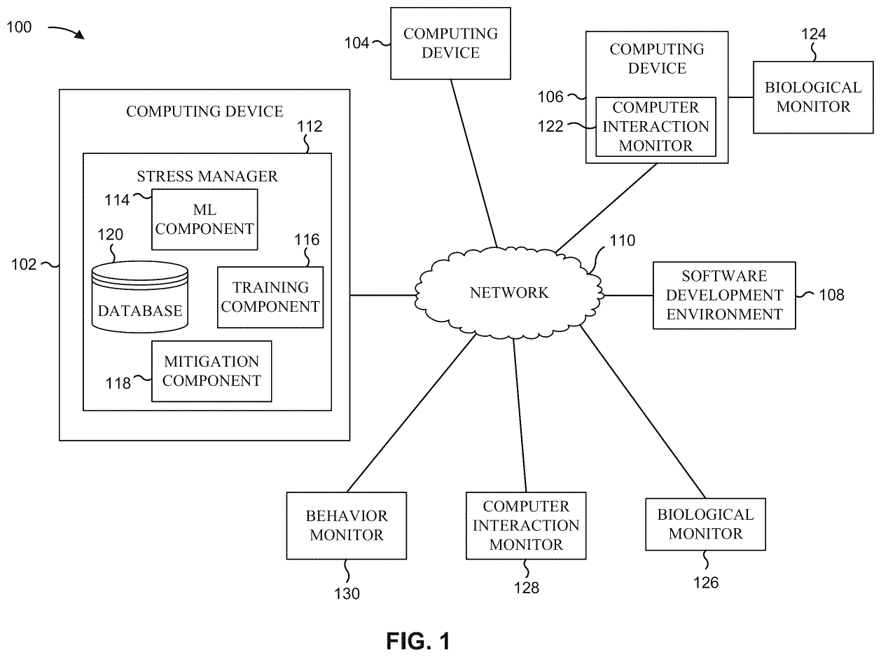

FIG. 1 is a block diagram of an example computing environment 100 for monitoring and managing stress levels in a software development environment. The computing environment 100 may be implemented using various hardware configurations, including distributed systems, cloud-based architectures, or combinations thereof. As shown, the computing environment 100 includes multiple computing devices 102, 104, 106 connected through a network 110. A software development environment 108 is also connected to the network 110.

Computing device 102 contains a stress manager 112 that includes a machine learning component 114, a training component 116, and a mitigation component 118. The stress manager 112 may be implemented as a software application, a hardware module, or a combination thereof. In some implementations, the stress manager 112 may be distributed across multiple computing devices or may be implemented as a cloud-based service. The stress manager 112 interfaces with a database 120 for storing and retrieving data related to stress measurements, user profiles, and historical project information.

The machine learning component 114 may include one or more machine learning models, such as neural networks, decision trees, or support vector machines, designed to analyze stress-related data and make predictions. An ML component refers to software and/or hardware capable of performing ML. ML is a subset of artificial intelligence (AI) that involves the development of algorithms and statistical models enabling computers to perform tasks without explicit programming. ML leverages large datasets to identify patterns, make decisions, and improve over time based on experience. ML focuses on creating systems that can learn from data, adapt to new inputs, and generate predictions or actions.

For example, an ML component may be or include one or more ML models, ML algorithms, and/or ML systems including combinations of ML algorithms and ML models. An ML component may be implemented on any number of different hardware devices and may include one or more machine learning models. ML is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in ML, a computer can be provided with examples and be trained to perform a task such as prediction or classification, without the programmer encoding explicit instructions for the task. ML explores the study and construction of algorithms, also referred to herein as tools, models, and/or components, which may learn from existing data and make predictions about new data. Such ML tools operate by building a model from example training data in order to make data-driven predictions or decisions expressed as outputs or assessments. Although example embodiments are presented with respect to a few ML models, the principles presented herein may be applied to other ML models. In some example embodiments, different ML models may be used. ML models may include, for example, K-means clustering models, linear regression models, logistic regression (LR) models, Naive-Bayes models, random forest (RF) regression models, gradient boost models, neural networks (NN), matrix factorization models, large language models (LLMs), and/or support vector machines (SVMs), among other examples.=

In some implementations, the machine learning component 114 may utilize ensemble learning techniques, combining multiple models to improve prediction accuracy. The machine learning component 114 may be trained on historical data to recognize patterns indicative of stress in software development contexts. The machine learning component 114 may employ a variety of techniques to process and analyze the HCl data collected from users. In some implementations, the component may utilize deep learning architectures, such as convolutional neural networks (CNNs) or recurrent neural networks (RNNs), to extract complex patterns from time-series data like keystroke dynamics or mouse movements. These neural network models may be designed to capture both short-term and long-term dependencies in the data, allowing for the detection of subtle changes in user behavior that may indicate increasing stress levels. Additionally, the machine learning component 114 may incorporate attention mechanisms to focus on the most relevant aspects of the input data, potentially improving the accuracy of stress predictions.

In some cases, the machine learning component 114 may implement a multi-modal approach, combining different types of HCl data to create a more comprehensive stress profile. For example, it may simultaneously analyze keystroke patterns, mouse movements, voice data, and facial expressions captured during video conferences. This multi-modal analysis may be achieved through the use of fusion techniques, such as early fusion (combining raw data before processing) or late fusion (combining predictions from separate models). The component may also employ transfer learning techniques, allowing it to leverage pre-trained models on larger datasets and fine-tune them for individual users. This approach may help in addressing the challenge of limited data for new users while still providing personalized stress predictions. Furthermore, the machine learning component 114 may incorporate online learning capabilities, allowing it to continuously update and refine its models as new data becomes available, ensuring that the stress predictions remain accurate and relevant over time.

The training component 116 may be configured to train the machine learning models of the machine learning component 114. The training component 116 may employ various training techniques, such as supervised learning, unsupervised learning, or reinforcement learning, depending on the nature of the available data and the specific stress prediction tasks. In some implementations, the training component 116 may utilize transfer learning to adapt pre-trained models to the specific context of software development stress management.

The training component 116 may employ a multi-stage approach to train and retrain the machine learning models of the machine learning component 114. In an initial phase, the training component 116 may utilize a combination of supervised and unsupervised learning techniques to establish baseline models. For supervised learning, the training component 116 may use labeled datasets that pair HCl data with known stress levels, potentially derived from self-reported stress assessments or data from biological monitoring devices used during calibration periods. Unsupervised learning techniques, such as clustering algorithms, may be applied to identify patterns in unlabeled HCl data that correlate with different stress states. This dual approach may allow the system to capture both explicit and implicit indicators of stress in software development contexts.

As new data becomes available, the training component 116 may implement an iterative retraining process to refine and update the models. This process may involve techniques such as online learning and incremental learning, which allow the models to adapt to new patterns and trends in real-time without requiring a complete retraining on the entire dataset. The training component 116 may also incorporate a feedback loop that takes into account the efficacy of stress mitigation strategies recommended by the mitigation component 118. By analyzing the outcomes of these interventions, the training component 116 may adjust the models to improve their predictive accuracy and the relevance of their recommendations. In some implementations, the training component 116 may utilize reinforcement learning techniques, where the model's performance in accurately predicting stress levels and suggesting effective interventions is used as a reward signal to guide further optimization.

The training component 116 may also leverage transfer learning techniques to enhance the performance of the machine learning models, particularly when dealing with new users or projects with limited historical data. In this approach, the training component 116 may start with pre-trained models that have been developed on larger, more general datasets related to stress and HCl patterns. These models may then be fine-tuned using the specific data available for each user or project, allowing the system to quickly adapt to individual characteristics while benefiting from broader patterns learned across a wider population. Additionally, the training component 116 may implement techniques such as few-shot learning or meta-learning to improve the system's ability to generalize from limited examples, enabling more rapid personalization of stress predictions for new users joining software development teams.

The mitigation component 118 may be configured to generate and implement stress reduction strategies based on the outputs of the machine learning component 114. The mitigation component 118 may interface with project management tools, scheduling systems, or human resources databases to suggest interventions such as workload adjustments, team reconfigurations, or wellness program recommendations. In some implementations, the mitigation component 118 may employ a rule-based system in conjunction with machine learning outputs to determine appropriate stress mitigation strategies.

The mitigation component 118 may generate a mitigation plan tailored to address the specific stress factors identified for each user or team. This plan may encompass a range of strategies, including recommended actions, updated role assignments, scheduling of health checkups, team well-being initiatives, and suggestions for time off. In some cases, the mitigation plan may be dynamically adjusted based on real-time stress measurements and project timelines. The mitigation component 118 may analyze historical data on the effectiveness of various interventions to refine and optimize the mitigation strategies over time.

The mitigation plan may include both individual and team-level interventions. For individual users, the plan may suggest personalized stress management techniques, such as mindfulness exercises, time management strategies, or recommendations for ergonomic improvements to their work environment. At the team level, the mitigation plan may propose modifications to project schedules, redistribution of tasks, or the introduction of collaborative tools to improve communication and reduce stress-inducing bottlenecks. In some implementations, the mitigation component 118 may interface with project management software to automatically adjust deadlines or workloads based on detected stress levels across the team.

The creation of the mitigation plan may involve a multi-step process that takes into account various factors. Initially, the mitigation component 118 may analyze the stress content received from the machine learning component 114 to identify the primary sources of stress. It may then cross-reference this information with a database of effective interventions and best practices in stress management. The mitigation component 118 may consider factors such as the user's role, the current phase of the project, and any relevant organizational policies when formulating recommendations. In some cases, the mitigation plan may be presented to team leaders or HR personnel for approval before implementation, allowing for human oversight in the stress management process.

The computing environment 100 includes multiple monitoring components distributed across the network 110. For example, computing device 106 includes a computer interaction monitor 122 and is connected to a biological monitor 124. The computer interaction monitor 122 may track various aspects of user interaction with computing devices, such as keystroke dynamics, mouse movements, or application usage patterns. In some implementations, the computer interaction monitor 122 may utilize advanced input analysis techniques, such as pressure-sensitive keyboards or eye-tracking systems, to gather more nuanced interaction data.

The biological monitor 124 may include devices such as wearable heart rate monitors, skin conductance sensors, or even more advanced technologies like portable electroencephalogram (EEG) devices. In some implementations, the biological monitor 124 may be integrated into everyday objects like office chairs or computer peripherals to provide continuous, non-invasive monitoring. The data from these monitors may be used to corroborate and enhance the stress assessments derived from computer interaction data.

An independent biological monitor 126 and computer interaction monitor 128 are connected separately to the network 110. This distributed monitoring approach allows for flexibility in data collection and may accommodate various workplace setups or remote work scenarios. In some implementations, these additional monitors may be mobile devices or specialized sensors deployed in different areas of a software development workspace.

A behavior monitor 130 is also connected to the network 110 to collect behavioral data. This may include analysis of communication patterns, meeting participation, code commit frequency, or other metrics relevant to software development processes. In some implementations, the behavior monitor 130 may employ natural language processing techniques to analyze the content and tone of written communications or verbal interactions during team meetings.

The behavior monitor 130 may incorporate a variety of components to gather comprehensive data on facial expressions, body language, social interactions, and work habits. For facial expression analysis, the behavior monitor 130 may utilize computer vision systems equipped with high-resolution cameras and advanced image processing algorithms. These systems may track micro-expressions, eye movements, and changes in facial muscle activity to infer emotional states and stress levels. In some implementations, the facial analysis component may use infrared cameras to detect subtle changes in skin temperature, which can be indicative of stress or emotional responses.

To capture body language data, the behavior monitor 130 may employ a combination of depth-sensing cameras, wearable devices, and posture analysis software. Depth-sensing cameras may track overall body posture and movements, while wearable devices such as smart watches or fitness trackers may provide data on gestures, fidgeting, or changes in physical activity levels. The behavior monitor 130 may include pressure-sensitive floor mats or chair sensors to detect shifts in sitting positions or standing patterns, which may correlate with stress or discomfort levels. In some cases, the behavior monitor 130 may utilize machine learning algorithms to analyze this multimodal data and identify patterns associated with different stress states or work behaviors.

For monitoring social interactions and work habits, the behavior monitor 130 may integrate with various communication and productivity tools used in the software development environment. This may include analyzing email patterns, chat logs, and collaboration platform usage to assess communication frequency, sentiment, and team dynamics. The behavior monitor 130 may also track code repository activities, such as commit frequency, code review patterns, and issue resolution times, to gauge work habits and potential stress indicators. In some implementations, the behavior monitor 130 may use audio analysis tools to process voice data from meetings or calls, examining factors such as speech rate, pitch variation, and linguistic markers that may indicate stress or emotional states. These components may work together to provide a holistic view of an individual's behavior and stress levels within the context of their work environment.

As indicated above, FIG. 1 is provided as an example. Other examples may differ from what is described with regard to FIG. 1. The number and arrangement of devices and components shown in FIG. 1 are provided as an example. There may be additional devices or components (e.g., a large number of devices or components), fewer devices or components, different devices or components, or differently arranged devices or components than those shown in FIG. 1. Furthermore, two or more devices or components shown in FIG. 1 may be implemented within a single device or component, or a single device or component shown in FIG. 1 may be implemented as multiple, distributed devices or components. Additionally, or alternatively, a set of devices or components (e.g., one or more devices or components) shown in FIG. 1 may perform one or more functions described as being performed by another set of devices or components shown in FIG. 1.

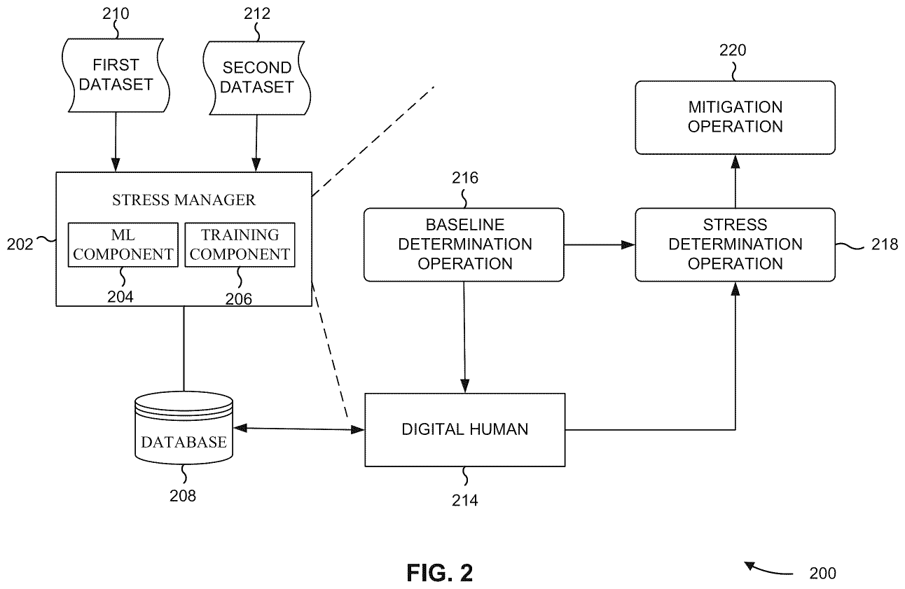

FIG. 2 illustrates a block diagram of a stress management system 200. The stress management system 200 may be implemented using various hardware configurations, including distributed systems, cloud-based architectures, or combinations thereof. For example, the stress management system 200 may be, be similar to, include, or be included in the computing environment 100 shown in FIG. 1 (or one or more components thereof). As shown, the stress management system 200 includes a stress manager 202 that contains a machine learning component 204 and a training component 206. The stress manager 202 interfaces with a database 208 for data storage and retrieval. In some implementations, the stress manager 202 may be, be similar to, include, or be included in the stress manager 112 shown in FIG. 1. Similarly, the ML component 204 and the training component 206 may be, be similar to, include, or be included in the ML component 114 and the training component 116, respectively, shown in FIG. 1.

The stress manager 202 may be implemented as a software application, a hardware module, or a combination thereof. In some implementations, the stress manager 202 may be implemented on a single computing device, distributed across multiple computing devices, or may be implemented as a cloud-based service. The stress manager 202 may coordinate the various components of the stress management system 200 and process the stress-related data to generate insights and recommendations.

The machine learning component 204 may include one or more machine learning models, such as neural networks, decision trees, or support vector machines, designed to analyze stress-related data and make predictions. In some implementations, the machine learning component 204 may utilize ensemble learning techniques, combining multiple models to improve prediction accuracy.

The machine learning component 204 may employ a variety of techniques to process and analyze the HCl data collected from users. In some implementations, the component may utilize deep learning architectures, such as convolutional neural networks (CNNs) or recurrent neural networks (RNNs), to extract complex patterns from time-series data like keystroke dynamics or mouse movements. These neural network models may be designed to capture both short-term and long-term dependencies in the data, allowing for the detection of subtle changes in user behavior that may indicate increasing stress levels. The machine learning component 204 may be trained on historical data to recognize patterns indicative of stress in software development contexts.

The training component 206 may be configured to train the machine learning models of the machine learning component 204. The training component 206 may employ various training techniques, such as supervised learning, unsupervised learning, or reinforcement learning, depending on the nature of the available data and the specific stress prediction tasks. In some implementations, the training component 206 may utilize transfer learning to adapt pre-trained models to the specific context of software development stress management.

The training component 206 may employ a multi-stage approach to train and retrain the machine learning models of the machine learning component 204. In an initial phase, the training component 206 may utilize a combination of supervised and unsupervised learning techniques to establish baseline models. For supervised learning, the training component 206 may use labeled datasets that pair HCl data with known stress levels, potentially derived from self-reported stress assessments or data from biological monitoring devices used during calibration periods.

The database 208 serves as a central repository for storing and managing data used by the stress manager 202. This may include historical stress measurements, user profiles, project timelines, and intervention outcomes. In some implementations, the database 208 may utilize advanced data storage and retrieval techniques, such as time-series databases or graph databases, to efficiently handle the complex relationships between stress factors, user characteristics, and project variables.

In operation, the stress manager 202 receives a first dataset 210 and a second dataset 212. The first dataset 210 and/or the second dataset 212 may be received, for example, from a computer interaction monitor (e.g., the computer interaction monitor 122 or 128 shown in FIG. 1), a biological monitor (e.g., the biological monitor 124 or 126 shown in FIG. 1), or a behavior monitor (e.g., the behavior monitor 130) shown in FIG. 1, among other examples.

The first dataset 210 may contain historical data on user interactions, stress measurements, and project outcomes. This dataset may be used for training the machine learning models and establishing baseline stress profiles. The second dataset 212 may represent real-time or recent data collected from users during their software development activities. This dataset may be used for making current stress predictions and generating recommendations.

The stress manager 202 uses the data from the first dataset 210 and second dataset 212 to create and maintain a digital human 214. The digital human 214 represents a virtual model of the user that captures their unique stress characteristics and responses. For example, the digital human 214 may include data on the user's typical keystroke patterns, mouse movements, and voice tone during both stressed and non-stressed states. In some implementations, the digital human 214 may be visualized as an avatar that mimics the user's behaviors. Some implementations may represent the digital human 214 as a set of data points or a mathematical model without a visual component.

To further develop the digital human 214, the stress manager 202 may perform a number of operations including, for example, a baseline determination operation 216, a stress determination operation 218, and a mitigation operation 220. The baseline determination operation 216 establishes initial parameters for the digital human 214, while the stress determination operation 218 processes ongoing stress measurements. The mitigation operation 220 receives output from the stress determination operation 218 to generate appropriate responses.

The baseline determination operation 216 may involve collecting data from users during non-stressful periods or activities. This may include monitoring HCl data while users perform routine tasks, engage in team-building exercises, or work on low-pressure aspects of a project. The baseline data may be collected over an extended period to account for natural variations in user behavior and stress levels. In some implementations, the baseline determination operation 216 may also incorporate data from biological monitoring devices to establish a comprehensive baseline stress profile.

The baseline determination operation 216 may involve a multi-faceted approach to establish a comprehensive baseline stress profile for each digital human. In some implementations, this operation may begin by collecting data from users during various non-stressful periods and activities. For example, the system may monitor HCl data while users perform routine administrative tasks, participate in casual team meetings, or work on low-priority documentation. The baseline data collection may extend over several weeks or months to capture a wide range of normal behavioral patterns and account for natural variations in user behavior and stress levels. In some cases, the system may use machine learning algorithms to identify periods of low stress automatically by analyzing patterns in the collected data, such as consistent typing speeds, regular mouse movements, or calm voice tones during voice communications.

The baseline determination operation 216 may also incorporate data from multiple sources to create a more robust baseline profile. In addition to HCl data, the operation may integrate information from biological monitoring devices, such as heart rate variability monitors or skin conductance sensors, to correlate physiological responses with behavioral patterns. The system may also consider environmental factors, such as noise levels, temperature, or time of day, to contextualize the baseline measurements. In some implementations, the baseline determination operation 216 may include periodic self-reported stress assessments from users, allowing for calibration of the objective measurements against subjective experiences of stress.

To refine the baseline profile, the baseline determination operation 216 may employ adaptive techniques that continuously update the baseline over time. For instance, the system may use a sliding window approach, where recent non-stressful periods are given more weight in determining the current baseline. This approach may allow the system to adapt to gradual changes in a user's behavior or stress responses over time. In some implementations, the operation may incorporate feedback mechanisms where users can flag periods of unusually low or high stress, helping to fine-tune the baseline determination. In some cases, the system may also compare individual baselines with team or department averages to identify any significant deviations that might require further investigation or adjustment.

The stress determination operation 218 analyzes ongoing HCl data and compares it to the established baseline to identify potential stress indicators. This operation may utilize the machine learning models trained by the machine learning component 204 to interpret complex patterns in user behavior. The stress determination operation 218 may consider various factors such as changes in typing speed, mouse movement patterns, voice tone variations, and even the content of written communications. In some implementations, this operation may also take into account contextual information such as project deadlines, team dynamics, or external factors that might influence stress levels.

The stress determination operation 218 may employ a multi-modal approach to analyze ongoing HCl data and compare it to the established baseline. In some implementations, the stress determination operation 218 may utilize a combination of time-series analysis, natural language processing, and computer vision techniques to process various types of input data. For example, the system may analyze keystroke dynamics by examining the timing patterns between key presses and releases, potentially identifying increased error rates or changes in typing rhythm that may indicate elevated stress levels. Simultaneously, the stress determination operation 218 may analyze mouse movement data, looking for patterns such as increased cursor speed, more erratic movements, or changes in click behavior that deviate from the user's baseline.

In addition to HCl data, the stress determination operation 218 may incorporate analysis of voice data collected during online meetings or voice memos. The system may examine features such as speech rate, pitch variability, and the presence of vocal fry or tremors, which may be indicative of stress. Natural language processing techniques may be applied to analyze the content and sentiment of written communications, such as emails, chat messages, or code comments, to detect changes in language use that may reflect increased stress levels. In some cases, the stress determination operation 218 may process video data from webcams during online meetings, using computer vision algorithms to detect facial expressions, micro-expressions, or changes in posture that may suggest elevated stress.

The stress determination operation 218 may utilize advanced machine learning techniques to integrate and interpret these diverse data streams. For instance, the system may employ ensemble methods that combine predictions from multiple models, each specialized in analyzing a specific type of data. These ensemble models may be weighted based on their historical accuracy or the current context of the user's work. In some implementations, the stress determination operation 218 may use recurrent neural networks (RNNs) or long short-term memory (LSTM) networks to capture temporal dependencies in the data, allowing the system to detect stress patterns that evolve over time. The stress determination operation 218 may incorporate attention mechanisms to focus on the most relevant features of the input data, potentially improving the accuracy of stress detection in complex, real-world scenarios. In some implementations, the stress determination operation 218 may adapt its analysis based on individual user characteristics, project phases, or team dynamics, using transfer learning techniques to fine-tune pre-trained models for specific contexts or users.

The mitigation operation 220 generates recommendations and interventions based on the output of the stress determination operation 218. These recommendations may range from simple suggestions for breaks or stress-reduction exercises to more complex interventions such as workload redistribution or team restructuring. The mitigation operation 220 may interface with project management tools or HR systems to implement some of its recommendations automatically. In some implementations, the mitigation operation 220 may employ a rule-based system in conjunction with machine learning outputs to determine the most appropriate stress mitigation strategies for each user or team.

The components are arranged in a hierarchical structure, with data flowing from the datasets through the stress manager 202 to the digital human 214, and then through the sequence of determination and mitigation operations. This structure allows for a systematic approach to stress management, from data collection and analysis to personalized intervention strategies. The continuous flow of data and feedback through this system enables ongoing refinement of the stress management process, potentially leading to more accurate predictions and more effective interventions over time.

As indicated above, FIG. 2 is provided as an example. Other examples may differ from what is described with regard to FIG. 2. The number and arrangement of devices, components, and operations shown in FIG. 2 are provided as an example. There may be additional devices, components, or operations (e.g., a large number of devices, components, or operations), fewer devices, components, or operations, different devices, components, or operations, or differently arranged devices, components, or operations than those shown in FIG. 2. Furthermore, two or more devices, components, or operations shown in FIG. 2 may be implemented within a single device, component, or operation, or a single device, component, or operation shown in FIG. 2 may be implemented as multiple, distributed devices, components, or operations. Additionally, or alternatively, a set of devices, components, or operations (e.g., one or more devices, components, or operations) shown in FIG. 2 may perform one or more functions described as being performed by another set of devices, components, or operations shown in FIG. 2.

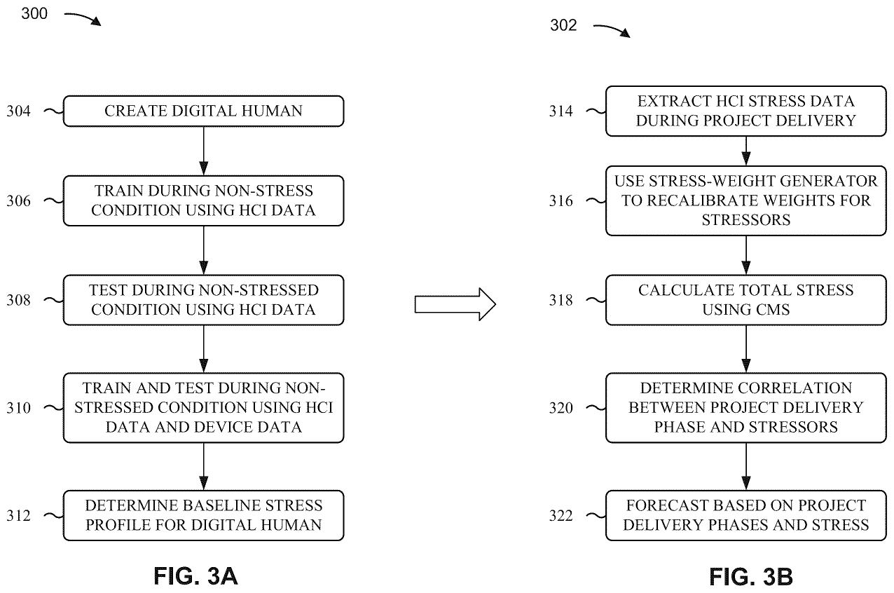

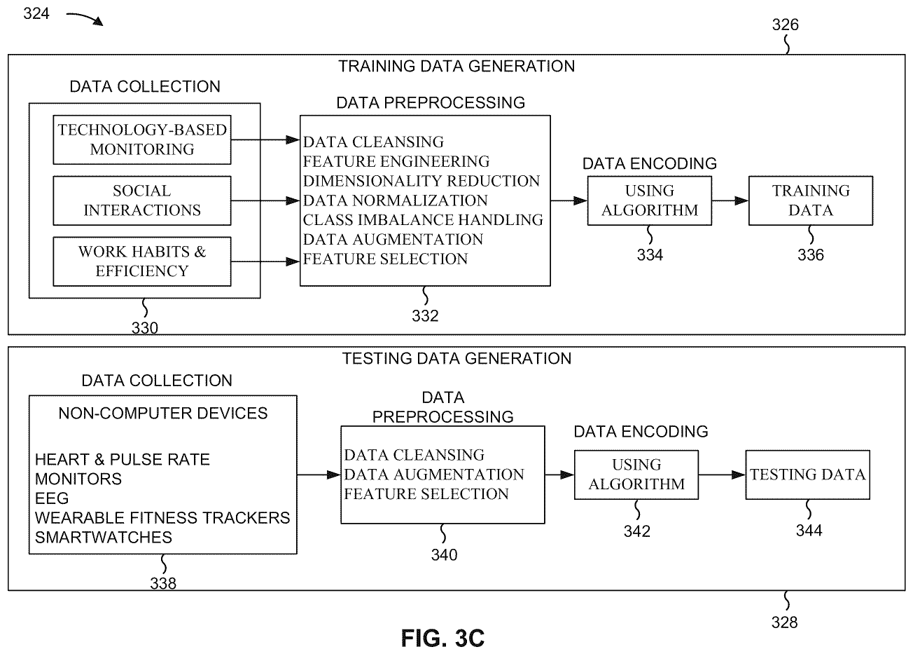

FIGS. 3A and 3B are flowcharts illustrating examples of processes 300 and 302, respectively, for occupational stress management using machine learning. The processes 300 and 302 may be implemented by the stress management system 200 described in relation to FIG. 2, or by other suitable systems or components. In some implementations, the processes 300 and 302 may be executed in parallel or in a different order than shown.

At 304, the process 300 includes creating a digital human. The digital human, as described earlier, represents a virtual model of a user that captures their unique stress characteristics and responses. In some implementations, the digital human may be created based on demographic information such as age, gender, job role, or work experience. For example, the digital human for a senior software developer may have different baseline stress parameters compared to a junior developer. Some implementations may incorporate additional factors such as personality traits or historical stress data from previous projects to create a more comprehensive digital human model.

At 306, training occurs during non-stress conditions using HCl data. This step involves collecting and analyzing human-computer interaction data while the user performs tasks in a relaxed environment. HCl data may include keystroke dynamics, mouse movements, voice patterns, or facial expressions captured during routine activities. For instance, the system may monitor a developer's typing speed and accuracy while they work on documentation or engage in code reviews without time pressure. In some implementations, this training phase may extend over several days or weeks to capture a wide range of non-stressful interactions.

At 308, the process 300 involves testing during non-stressed conditions using HCl data. This step serves to validate the baseline stress profile established during the training phase. The system may present the user with various low-stress scenarios and collect HCl data to ensure consistency with the training data. For example, the user might be asked to participate in team-building exercises or work on personal projects while their interactions are monitored. Some implementations may incorporate gamified testing scenarios designed to maintain a relaxed state while collecting diverse HCl data.

At 310, training and testing are conducted during non-stressed conditions using HCl data and device data. This step introduces data from external monitoring devices to corroborate and enhance the HCl-based stress assessments. Device data may include heart rate variability, skin conductance, or even brain wave patterns from portable EEG devices. For instance, a smartwatch might track the user's heart rate or movement patterns during a typical workday, providing physiological context to the HCl data. Some implementations may use more advanced monitoring tools, such as pressure-sensitive chairs or eye-tracking systems, to gather additional biometric data.

At 312, a baseline stress profile is determined for the digital human. This profile represents the user's typical stress responses and behaviors under normal, non-stressful working conditions. The baseline stress profile may include average values for various HCl metrics, such as typical typing speed, mouse movement patterns, or voice characteristics, as well as physiological baselines from device data. In some implementations, the baseline profile may be visualized as a multi-dimensional model, allowing for easy comparison with future stress measurements.

To develop the baseline profile and perform subsequent stress measurements, an algorithm referred to as contextual multidimensional stressors (CMS) may be used. An example of the CMS algorithm is described herein, though it should be understood that any number of modifications may be made to the CMS algorithm in implementation. Additionally or alternatively, a different algorithm may be used to perform the functions described herein.

The CMS algorithm includes defining a variable, E, to represent users (e.g., team members), as follows:

$$E = \{ {e}_{1} , {e}_{2} , … , {e}_{n} \} ,$$

where n is the total number of team members. A stress parameter variable (from HCl data and/or biological monitoring devices, referred to interchangeably herein as health measurement devices (HMDs)), ST, may be defined as:

$$S T = \{ s {t}_{1} , {st}_{2} , … , {st}_{k} \} = s {t}_{i} , i = 1 , 2 , … , k ,$$

where k is the total number of stress parameters under consideration (e.g., keyboard pressure, mouse click rate, heart rate, etc.). A stress measurement variable, SM, may be defined as:

$$SM = \{ s {m}_{1} , {sm}_{2} , … , {sm}_{k} \} = s {m}_{i} , i = 1 , 2 , … , k ,$$

where, for a given team member eₐ, each smᵢ corresponds to the measured value of a particular stress parameter stᵢ.

To develop a baseline profile for a team member, a first dataset is obtained that includes ST measurements at different times, T, during a time period:

$$T = \{ {t}_{0} , {t}_{1} , … , {t}_{τ} \} ,$$

where each tₜ is a time instance within the specified time period. In some implementations, the first dataset may be divided into two subsets: a training data set that includes training data (HCl data) for each stress parameter received from one or more computer interaction monitors (e.g., the computer interaction monitor 122 or 128 shown in FIG. 1) and a test data set that includes test data (HMD data) received from biological monitors (e.g., the biological monitor 124 or 126 shown in FIG. 1). In some implementations, the training data also may include behavior data (e.g., social interaction data, work habit data, etc.) received from a behavior monitor (e.g., the behavior monitor 130 shown in FIG. 1). Thus, for each user, eₐ, the HCl data may include a number of stress parameters stᵢ_{_{HCl}} and corresponding stress measurements smᵢ_{_{HCl}}, and the HMD data may include a number of stress parameters stᵢ_{_{HMD}} and corresponding stress measurements smᵢ_{_{HMD}}.

This divided data may be used to generate a baseline profile. In some implementations, the baseline profile may be refined based on a weighted average of stress measurements associated with stress parameters, where:

$${e}_{a} ( HCI ) = > \frac{\begin{matrix}\sum ( {st}_{{1}_{HCI}} ( {sm}_{{1}_{HCI}} ) * {w}_{{1}_{HCI}} + {st}_{{2}_{HCI}} ( {sm}_{{2}_{HCI}} ) * {w}_{{2}_{HCI}} + \\ … + {st}_{{r}_{HCI}} ( {sm}_{{r}_{HCI}} ) * {w}_{{r}_{HCI}} )\end{matrix}}{k} , and$$

$${e}_{a} ( HMD ) = > \frac{\begin{matrix}\sum ( {st}_{{1}_{HMD}} ( {sm}_{{1}_{HMD}} ) * {w}_{{1}_{HMD}} + {Sst}_{{2}_{HMD}} ( {sm}_{{2}_{HMD}} ) * {w}_{{2}_{HMD}} + \\ … + {st}_{{s}_{HMD}} ( {sm}_{{s}_{HMD}} ) * {w}_{{s}_{HMD}} )\end{matrix}}{k} ,$$

where w is a stress parameter weight, and where r+s=k.

The stress parameter weight, w, may be calculated using an algorithm that may be referred to as a stress weight generator engine (SWGE). The SWGE may be a model that, using data from stress-measuring devices, determines the stress parameter weight for each of the selected HCl parameter and fine-tunes the model for accuracy. The SWGE takes, as input, the value of multiple stress parameters from HCl devices in different timestamps in non-stress environments based on historical data for a user eₐ. The SWGE iteratively calculates w for each parameter, compares the resulting stress calculations to new measurements for that user and compares similarities with historical data during non-stressed times to get the nearest matching values and/or topmost similar values, which may be used as the stress parameter weight w for the user.

In some implementations, baseline profiles and new profiles for a user may be represented as vectors using a vector space model (VSM), which is a mathematical framework used in information retrieval and NLP. Thus, to generate a baseline profile, P, for a given user eₐ, the baseline measurements (non-stressed condition) taken at various times may be stored as a set of vectors:

$${P}_{j} = ( {P}_{j , 1} , {P}_{j , 2} , … , {P}_{j , k} ) , j = 1 , 2 , … , m ,$$

where each Pⱼ is a k-dimensional vector describing the user's stress parameters in a non-stressed state (e.g., P_{j,1} might be the user's averacr mouse click rate, P_{j,2} might be average keystroke pressure, etc.).

Similarly, a new set of measurements (also obtained in a non-stressed or partially stressed state) may be a new profile, NP, associated with the user eₐ:

$${NP}_{d} = ( {NP}_{1} , {NP}_{2} , … , {NP}_{k} ) ,$$

where each NP_{d} corresponds to the newly measured value for the i-th parameter (e.g., new average mouse click rate).

To find which historical profile Pⱼ is most similar to the new profile NP_{d}, the SWGE may employ the cosine similarity metric:

$${S}_{d , j} = cosine\_similarity ( {NP}_{d} , {P}_{j} ) = \frac{{\sum }_{i = 1}^{k} ( {NP}_{i} \times {P}_{j , i} )}{\sqrt{{\sum }_{i = 1}^{k} {( {NP}_{i} )}^{2}} \times \sqrt{{\sum }_{i = 1}^{k} {( {P}_{j , i} )}^{2}}} ,$$

where the profile P_{j*} with the highest cosine similarity to NP_{d} may be deemed the most similar baseline profile. The corresponding similarity value, S_{d,j*}, may be used as a stress parameter weight w for the corresponding stress parameter. For example, once P_{j*} (the most similar profile) is identified, the SWGE may use the values from P_{j*} to determine the weight vector W. Conceptually:

$$W = ( {w}_{1} , {w}_{2} , … , {w}_{k} ) ,$$

where each wᵢ indicates how much influence parameter stᵢ has on an overall stress measurement. The baseline measurements from P_{j*} (and, in some implementations, additional calibration with HMD data) guide the assignment of wᵢ.

To illustrate the operation of the SWGE, consider a simplified example with three stress parameters:

$${st}_{1} = mouse click rate ( HCl ) ,$$

$${st}_{2} = voice pitch ( HCl ) , and$$

$${st}_{3} = heart rate ( HMD ) .$$

Suppose a team member eₐ has three historical baseline vectors, each reflecting an average measurement:

$${P}_{1} = ( 10 , 200 , 80 ) ,$$

$${P}_{2} = ( 12 , 190 , 78 ) , and$$

$${P}_{3} = ( 9 , 210 , 82 ) .$$

In these vectors, the first component is the mouse click rate (clicks/min), the second component is the voice pitch (e.g., Hz), and the third component is the heart rate (beats/min). Now a new set of non-stressed measurements is taken for eₐ:

$$N {P}_{d} = ( 11 , 195 , 80 ) .$$

The SWGE may compute cosine similarity between NP_{d} and each Pⱼ:

$${S}_{d , 1} = \frac{( 11 \times 10 ) + ( 195 \times 200 ) + ( 80 \times 80 )}{\sqrt{{11}^{2} + {195}^{2} + {80}^{2}} \times \sqrt{{10}^{2} + {200}^{2} + {80}^{2}}}$$

$${S}_{d , 2} = \frac{( 11 \times 12 ) + ( 195 \times 190 ) + ( 80 \times 78 )}{\sqrt{{11}^{2} + {195}^{2} + {80}^{2}} \times \sqrt{{12}^{2} + {190}^{2} + {78}^{2}}}$$

$${S}_{d , 3} = \frac{( 11 \times 9 ) + ( 195 \times 210 ) + ( 80 \times 82 )}{\sqrt{{11}^{2} + {195}^{2} + {80}^{2}} \times \sqrt{{9}^{2} + {210}^{2} + {82}^{2}}}$$

and may select the P_{j*} with the highest S_{d,j}. For example, assuming P₂ is identified as the most similar profile, the SWGE may determine the stress parameter weight vector W=(w₁, w₂, w₃) based on how P₂ compares to the new data. If P₂ is also calibrated against heart rate data from HMD, the system may refine these weights accordingly. For illustration, the final weights might come out as W=(0.3, 0.4, 0.3).

The weightage value determined here is used as baseline weightage in non-stressed state to calculate the value of the respective stress parameters related to the health monitoring devices and HCl devices of the same user Ea.

For User Ea=>Ea(HCl)ΣST~Ea(HMD)ΣST.

Since health monitoring devices give more accurate results, the calculation done from HCl devices is calibrated against the reading of health measuring devices. If the reading has a high variance, it means the value of W determined isn't accurate for the digital human and needs to be modified. Multiple iteration with varied datasets may be required to determine the accurate weightage of the parameter W where the difference between HCl devices and Health monitoring devices is negligible.

Process 302 begins at 314 with extracting HCl stress data during project delivery. This step involves continual monitoring of the user's interactions with their computing devices during actual software development work. The system may track changes in typing patterns, code commit frequency, or communication styles as potential indicators of stress. For example, an increase in typos or more frequent use of the delete key might suggest rising stress levels. Some implementations may also analyze the content of written communications or code comments for linguistic markers of stress.

At 316, a stress weight generator (e.g., the SWGE described above) is used to recalibrate weights for stress parameters. This component, which may be part of a machine learning component or a training component (e.g., the ML component 114 or training component 116 shown in FIG. 1), adjusts the importance of different stress indicators based on their observed correlation with overall stress levels. For instance, if changes in mouse movement patterns are found to be more indicative of stress than changes in typing speed for a particular user, the system would assign a higher weight to mouse-related metrics. In some implementations, this recalibration process may occur in real-time, allowing the system to adapt to changing stress manifestations throughout a project's lifecycle.

At 318, total stress is calculated using the CMS. CMS refers to the comprehensive approach of considering multiple stress factors within the context of the software development environment. This calculation may involve a weighted sum of various stress indicators, normalized against the user's baseline profile. For example, the system might combine weighted scores from keystroke dynamics, voice analysis, and physiological data to produce a single stress measurement. Some implementations may employ more complex algorithms, such as machine learning models that can detect non-linear relationships between stressors and overall stress levels.

With reference to the implementation of the CMS described above, to establish the baseline stress for eₐ in a non-stressed state, one might use the mean of the weighted parameters:

$${BaselineStress}_{{e}_{a}} = \frac{( {st}_{1} \times {w}_{1} ) + ( {st}_{2} \times {w}_{2} ) + … + ( {st}_{k} \times {w}_{k} )}{k} .$$

In the simplified three-parameter example above:

$${BaselineStress}_{{e}_{a}} = \frac{( 10 \times 0.3 ) + ( 200 \times 0.4 ) + ( 80 \times 0.3 )}{3} ( if using {P}_{1} , for example ) .$$

During the project phase, new HCl readings (and possibly partial HMD readings) may be taken. The same weighting W might be used to produce:

$$ProjectStress {{e}_{a}}_{} = \frac{{\sum }_{i = 1}^{k} ( {st}_{i}^{( n e w )} \times {w}_{i} )}{k} ,$$

and the difference (or percentage change) between ProjectStressₑ_{ₐ}, and BaselineStressₑ_{ₐ} may indicate how much the stress has changed:

$$Δ \% = ( \frac{{ProjectStress}_{{e}_{a}} - {BaselineStress}_{{e}_{a}}}{{BaselineStress}_{{e}_{a}}} ) \times 100 .$$

At step 320, correlation is determined between project delivery phases and stressors. This step involves analyzing how stress levels fluctuate across different stages of software development, such as requirements gathering, coding, testing, and deployment. The system may identify patterns, such as consistently higher stress during code review phases or lower stress during documentation periods. In some implementations, this correlation analysis may extend to specific tasks within each phase, providing granular insights into stress-inducing activities. For instance, the system might detect that a particular developer experiences higher stress when working on front-end user interface components compared to back-end database operations. In some implementations, the stress values obtained above may be combined with other project data (phases, roles, time periods, etc.) to form a multidimensional dataset. An ML model (e.g., Decision Tree Regressor) may then be used to find relationships among different variables (roles, project phases) and stress levels.

At step 322, the process 300 may include forecasting based on project phases and stress. This predictive step utilizes historical stress data and project timelines to anticipate future stress levels. The forecasting model may consider factors such as upcoming deadlines, team dynamics, and individual stress patterns to project stress trajectories. For example, if a developer typically experiences high stress during the week leading up to a major release, the system might predict elevated stress levels for similar periods in future projects. Some implementations may incorporate external factors, such as organizational changes or market pressures, to refine stress forecasts. In some implementations, based on historical stress measurements and project schedules, a regression model (e.g., linear or polynomial regression) may be used to predict future stress levels. The model may compare performance metrics (like the R² score) to determine whether a simple or polynomial regression approach might be more reliable.

FIG. 3C illustrates a block diagram of a data processing system example 324 that includes two parallel data generation operations: a training data generation operation 326 and a testing data generation operation 328. This system exemplifies the data processing pipeline used to prepare information for the stress management model.

The training data generation operation 326 begins with a data collection operation 330 that receives input from technology-based monitoring, social interactions, or work habits and efficiency sources. Technology-based monitoring may include stress measuring devices like EEG, Heard Rate and Pulse Rate monitors, Keystroke and Mouse movement, automated tracking of software usage patterns, code repository activities, or digital communication logs. Social interactions data might encompass meeting attendance records, collaboration tool usage statistics, or sentiment analysis of team communications. Work habits and efficiency data could include metrics such as task completion rates, code quality scores, or time allocation across different project activities.

The collected data flows to a data pre-processing operation 332 where data cleansing, feature engineering, dimensionality reduction, data normalization, class imbalancing, data augmentation, or feature selection may occur. Data cleansing involves removing outliers, handling missing values, or correcting inconsistencies in the raw data. Feature engineering may create new, more informative variables from the existing data, such as deriving a “context switching frequency” metric from application usage logs. Dimensionality reduction techniques like Principal Component Analysis (PCA) might be employed to focus on the most relevant aspects of the data. Data normalization ensures that all features are on a comparable scale, while class imbalancing techniques address any disproportionate representation of stress levels in the dataset. Data augmentation may involve generating synthetic examples to expand the training set, particularly for underrepresented stress scenarios. Feature selection algorithms help identify the most predictive variables for stress assessment.

The pre-processed data then moves to a data encoding operation 334 using a processing algorithm, such as one or more components of the CMS algorithm, for producing training data 336. This encoding step transforms the cleaned and engineered features into a format suitable for machine learning models. For instance, categorical variables like project roles might be one-hot encoded, while time-series data from keystroke dynamics could be encoded using techniques like Fourier transforms or wavelet analysis. The resulting training data 336 represents a structured, machine-learning-ready dataset that captures the multifaceted nature of stress in software development environments.

The testing data generation operation 328 starts with monitoring devices 338 that include non-computer devices, heart & pulse rate monitors, EEG, or wearable fitness trackers/smartwatches. These devices provide physiological data that serves as ground truth for stress levels, against which the HCl-based predictions can be validated. Heart rate variability, for example, offers insights into the autonomic nervous system's response to stress, while EEG data can reveal stress-related changes in brain activity patterns.

The data from these devices flows to a data pre-processing operation 340 for cleaning and preparation. This step may involve synchronizing data streams from different devices, handling device-specific noise or artifacts, or aligning physiological measurements with timestamps from the HCl data. In some implementations, this pre-processing stage might also include extracting higher-level features from the raw physiological data, such as deriving stress indices from combinations of heart rate, skin conductance, or movement data.

The pre-processed data then moves through a data encoding operation 342 using a processing algorithm such as one or more components of the CMS algorithm, which generates testing data 344. This encoding process ensures that the physiological data is in a format compatible with the machine learning models trained on the HCl data. The testing data 344 serves as a benchmark against which the stress predictions based on HCl data can be evaluated and refined.

By maintaining separate but parallel pipelines for training and testing data, some implementations of the system ensures a robust validation process for its stress prediction models. This approach allows for continuous improvement of the stress assessment algorithms, as insights from the physiological testing data can be used to refine the feature engineering and model training processes in the HCl-based pipeline.

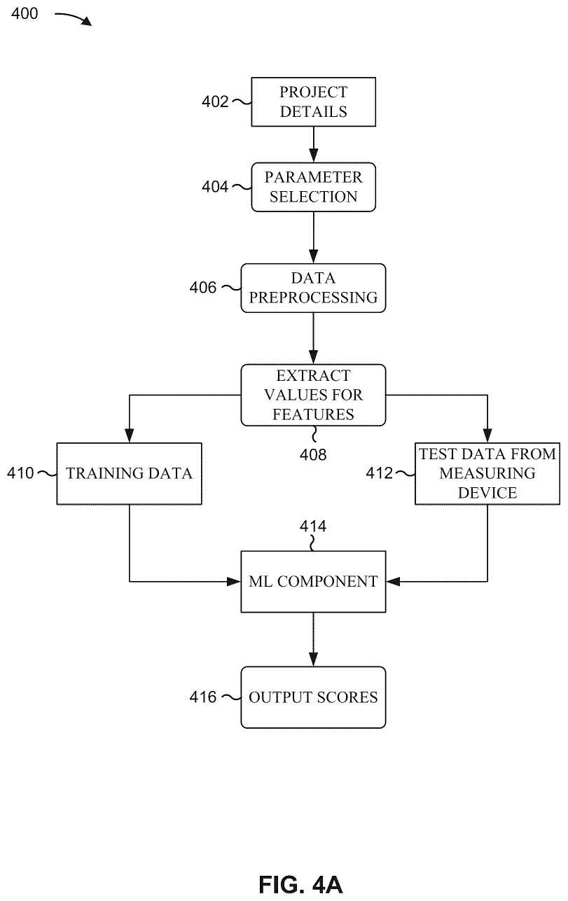

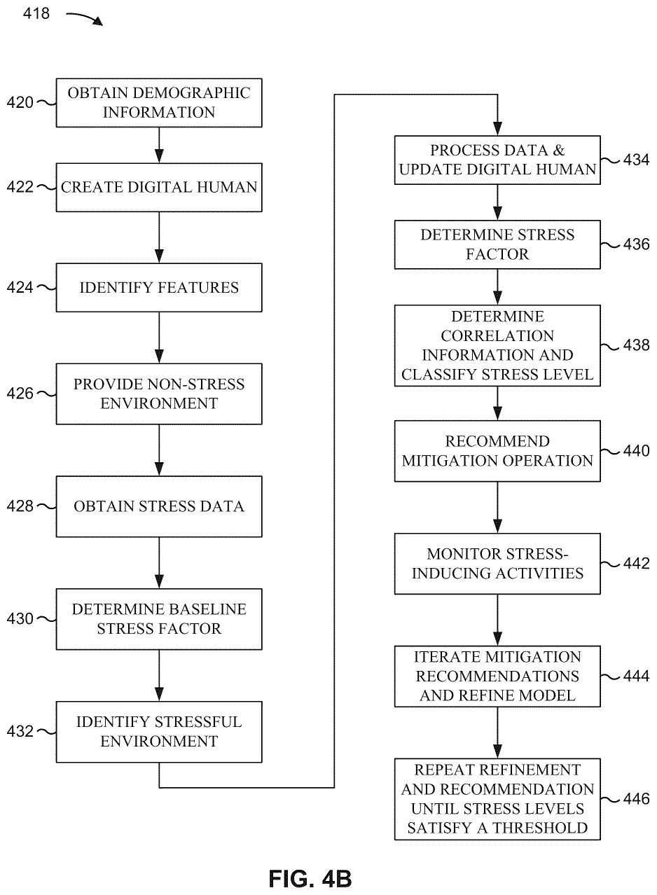

FIG. 4A illustrates a flowchart of a process 400 for processing data related to stress measurement in a software development environment. The process 400 may be implemented by the stress management system 200 described in relation to FIG. 2, or by other suitable systems or components. In some implementations, the process 400 may be executed in parallel with other processes or in a different order than shown.

At 402, project details are provided to a stress manager (e.g., the stress manager 112 shown in FIG. 1). This step involves gathering relevant information about the software development project that will be monitored for stress levels. Project details may include, but are not limited to, project timelines, team composition, project goals, or specific roles assigned to team members. In some implementations, the project details may be input manually by a project manager or team lead. In some implementations, the stress manager may automatically extract project details from existing project management tools or databases. For example, the stress manager may integrate with tools like JIRA or Microsoft Project to pull relevant project information.

At 404, parameter selection occurs. Parameter selection involves choosing the specific stress-related metrics that will be monitored throughout the project. These parameters may include both HCl data and other relevant factors. Examples of parameters that may be selected include keystroke dynamics, mouse movement patterns, voice tone analysis, facial expression metrics, or project-specific factors such as code commit frequency or bug fix rates. In some implementations, the parameter selection may be customized based on the nature of the project or the preferences of the organization. For instance, a project involving extensive user interface design might prioritize parameters related to mouse movements and visual attention, while a backend development project might focus more on keystroke dynamics and code complexity metrics.

At 406, data preprocessing is performed on the selected parameters. Data preprocessing may involve cleaning, normalizing, or transforming the raw data collected from various sources into a format suitable for analysis by the machine learning component. This step may include activities such as removing outliers, handling missing data, scaling numerical features, or encoding categorical variables. For example, keystroke timing data might be normalized to account for differences in typing speed between users, while categorical data like project roles might be one-shot encoded. In some implementations, the preprocessing step may also involve feature engineering, where new, more informative features are created from the existing data. For instance, the system might derive a “context switching frequency” feature from application usage logs.

At 408, values for features are extracted. Feature extraction involves deriving meaningful information from the preprocessed data that can be used as input for the machine learning models. This step may involve techniques such as dimensionality reduction, where the most relevant aspects of the data are identified and isolated. For example, from raw keystroke data, the stress manager might extract features like average typing speed, rhythm consistency, or error rate. From mouse movement data, features like cursor path efficiency or click precision might be derived. In some implementations, more advanced feature extraction techniques such as wavelet transforms for time-series data or bag-of-words models for text data might be employed.

From 408, the process 400 branches into two parallel paths. One path leads to step 410 for generating training data, while the other path leads to step 412 for collecting test data from measuring devices. This parallel approach, described in more detail above, allows for the simultaneous preparation of data for model training and validation.

Step 410 involves generating training data. Training data is the dataset used to teach the machine learning models to recognize patterns indicative of stress. Training data may include historical HCl data paired with known stress levels or outcomes. The training data may be collected over an extended period and may include data from multiple users and projects to ensure a diverse and representative dataset. In some implementations, the training data may be augmented with synthetic examples to cover a wider range of stress scenarios. For instance, the system might generate synthetic data representing extreme stress conditions that are rarely observed in real-world data collection.

Step 412 involves collecting test data from measuring devices. Test data is used to evaluate the performance of the trained machine learning models and ensure their accuracy in predicting stress levels. Test data may be collected using more direct stress measurement devices such as heart rate monitors, skin conductance sensors, or even portable EEG devices. The test data provides a “ground truth” against which the predictions based on HCl data can be validated. In some implementations, the test data collection may involve controlled experiments where participants are subjected to various levels of stress while their physiological responses and HCl patterns are recorded simultaneously.

Both paths converge at step 414, where an ML component (e.g., the ML component 114 shown in FIG. 1) processes both the training data and test data. The ML component may employ various algorithms and model architectures to learn the relationships between HCl patterns and stress levels. This may include techniques such as supervised learning, where the model learns to predict stress levels based on labeled examples, or unsupervised learning techniques that identify clusters or patterns in the data without explicit labels. In some implementations, the ML component may utilize ensemble methods, combining multiple models to improve prediction accuracy. For example, a combination of decision trees, neural networks, and support vector machines might be used to capture different aspects of the stress-HCl relationship.

At step 416, output scores are generated based on the ML component's analysis. These output scores represent the predicted stress levels or stress-related metrics for the monitored individuals or teams. The scores may be continuous values indicating a stress level on a scale, or they may be categorical, classifying stress levels into discrete categories such as low, medium, or high. In some implementations, the output scores may include confidence intervals or probability distributions to indicate the certainty of the predictions. These scores can then be used by project managers or team leads to make informed decisions about workload distribution, schedule adjustments, or stress mitigation strategies. In some implementations, the output scores may be provided to a mitigation component (e.g., the mitigation component 118 shown in FIG. 1), which may be configured to automatically perform mitigation operations based on the scores.

FIG. 4B illustrates a flowchart of a process 418 for creating and managing a digital human model for stress monitoring in software development environments. The process 418 may be implemented as part of the stress management system 200 described earlier, or as a standalone component within a larger stress monitoring framework.

At 420, demographic information may be obtained. Demographic information refers to the characteristics of the individual being monitored, which may influence their stress responses and baseline behavior. This information may include age, gender, job role, years of experience, educational background, and any other relevant personal or professional attributes. In some implementations, the demographic information may be collected through a questionnaire or imported from existing HR systems. For example, the system might consider factors such as whether the individual is a junior developer or a senior architect, as these roles may have different baseline stress profiles.

At step 422, a digital human is created based on the demographic information. The digital human is a virtual representation of the individual that encapsulates their unique characteristics and stress response patterns. This model serves as a baseline for stress analysis and prediction. In some implementations, the digital human may be represented as a set of parameters or a mathematical model. In some implementations, a digital human could be visualized as an avatar or a dashboard of key metrics. For instance, the digital human for a mid-career software engineer might include baseline metrics for typing speed, code complexity preferences, and typical working hours.

The process 418 continues to step 424, where features are identified. Feature identification involves determining the specific aspects of behavior and performance that will be monitored to assess stress levels. These features may include HCl metrics such as keystroke dynamics, mouse movement patterns, and application usage statistics, as well as work-related metrics like code commit frequency, meeting participation, or communication patterns. In some implementations, the feature set may be dynamically adjusted based on the individual's role or the nature of the project. For example, a quality assessment engineer's digital human might prioritize features related to bug reporting and test case execution, while a frontend developer's model might focus more on UI interaction patterns.

At 426, a non-stress environment is provided for baseline measurements. This step involves creating or identifying conditions where the individual is likely to be in a relaxed state, allowing for the establishment of baseline behavior patterns. A non-stress environment might include periods of routine work, team-building activities, or even controlled relaxation sessions. In some implementations, the system might use data from weekends or vacation periods as indicators of non-stress states. In some implementations, specific low-pressure tasks or simulations could be designed to elicit baseline behavior.

At 428, stress data is obtained in association with the non-stress environment. This data collection process captures the individual's typical behavior and physiological responses when not under significant work-related stress. The data collected may include HCl metrics, physiological measurements (if available), or self-reported stress levels. In some implementations, this data collection might occur over an extended period to account for natural variations in behavior and to establish a robust baseline. For example, the system might collect data over several weeks, including different times of day and various routine activities.

At 430, a baseline stress factor (referred to herein as a baseline profile) is determined from the collected data. The baseline stress factor represents the individual's typical stress level and behavior patterns under normal, non-stressful working conditions. This baseline serves as a reference point against which future stress measurements will be compared. In some implementations, the baseline stress factor might be represented as a multidimensional model, capturing various aspects of behavior and physiology. In some implementations, it could be distilled into a single numerical value or a set of key indicators. For instance, the baseline might include average typing speed, typical heart rate range, and usual patterns of application switching.

At 432, a stressful environment is identified. This step involves recognizing or creating conditions that are likely to induce work-related stress, allowing for the observation of stress responses. Stressful environments in software development might include approaching deadlines, complex debugging sessions, or high-stakes client presentations. In some implementations, the system might use project timelines and known high-pressure periods to automatically identify potentially stressful environments. In some implementations, team leads or the individuals themselves might flag periods of increased stress for more focused monitoring.

At 434, data is processed and the digital human is updated. This step involves analyzing the data collected during stressful periods and comparing it to the baseline measurements. The digital human model is then updated to reflect any observed changes in behavior or stress responses. This updating process ensures that the digital human remains an accurate representation of the individual's current stress profile. In some implementations, this update might occur in real-time, with the digital human continuously evolving based on incoming data. In some implementations, updates might be performed at regular intervals or after significant events.

At 436, a stress factor is determined based on the processed data. The stress factor quantifies the level of stress experienced by the individual, typically in comparison to their baseline state. This factor might be expressed as a numerical value, a categorical level (e.g., low, medium, high), or a more complex representation of stress across multiple dimensions. In some implementations, the stress factor might be calculated using machine learning algorithms that consider multiple inputs and their interactions. For example, a sudden decrease in typing accuracy combined with increased mouse movement erraticism and longer working hours might contribute to a high stress factor.

At 438, the process 418 involves determining correlation information and classifying stress levels. This step analyzes the relationships between various factors (such as project phases, specific tasks, or team dynamics) and observed stress levels. The system then classifies the current stress state of the individual based on these correlations and the calculated stress factor. In some implementations, this classification might use predefined thresholds or adaptive criteria that evolve based on historical data. For instance, the system might learn that a particular developer consistently shows signs of stress during code review phases, allowing for more nuanced classification of their stress levels in these periods.

At 440, a mitigation operation is recommended based on the stress classification. Mitigation operations are actions or interventions designed to reduce stress levels and improve well-being. These recommendations might include suggestions for breaks, workload adjustments, or specific stress-reduction techniques tailored to the individual. In some implementations, the mitigation recommendations might be integrated with project management tools, automatically suggesting task reassignments or deadline adjustments. In some implementations, the system might provide personalized suggestions directly to the individual, such as recommending a short walk or a mindfulness exercise during high-stress periods.

At 442, the process 418 involves monitoring stress-inducing activities. This ongoing monitoring process tracks specific tasks, project phases, or work patterns that consistently correlate with increased stress levels. By identifying these stress triggers, the system can provide more targeted and proactive stress management. In some implementations, this monitoring might involve detailed tracking of time spent on different types of tasks or analysis of communication patterns during high-stress periods. For example, the system might identify that long stretches of uninterrupted coding or frequent context switching between multiple projects are particularly stress-inducing for a specific developer.

At 444, the process 418 iterates mitigation recommendations and refines the model. Based on the observed effectiveness of previous mitigation strategies and ongoing stress monitoring, the system adjusts its recommendations and updates the digital human model. This iterative process allows for continuous improvement in stress prediction and management. In some implementations, this refinement might employ reinforcement learning techniques, where the system learns from the outcomes of its recommendations to improve future suggestions. In some implementations, periodic reviews with team leads or HR professionals might be used to validate and adjust the model's recommendations.

The process 418 concludes at step 446, where refinement and recommendation continue until stress levels satisfy a threshold. This step represents the ongoing nature of stress management, with the system continuously monitoring, analyzing, and intervening until stress levels are consistently maintained within acceptable limits. The threshold for satisfactory stress levels may be predefined based on organizational policies or dynamically adjusted based on individual and team performance metrics. In some implementations, this process might continue indefinitely, providing long-term stress management support throughout an individual's career. In some implementations, specific project-based or time-based goals for stress reduction might be set and monitored until achieved.

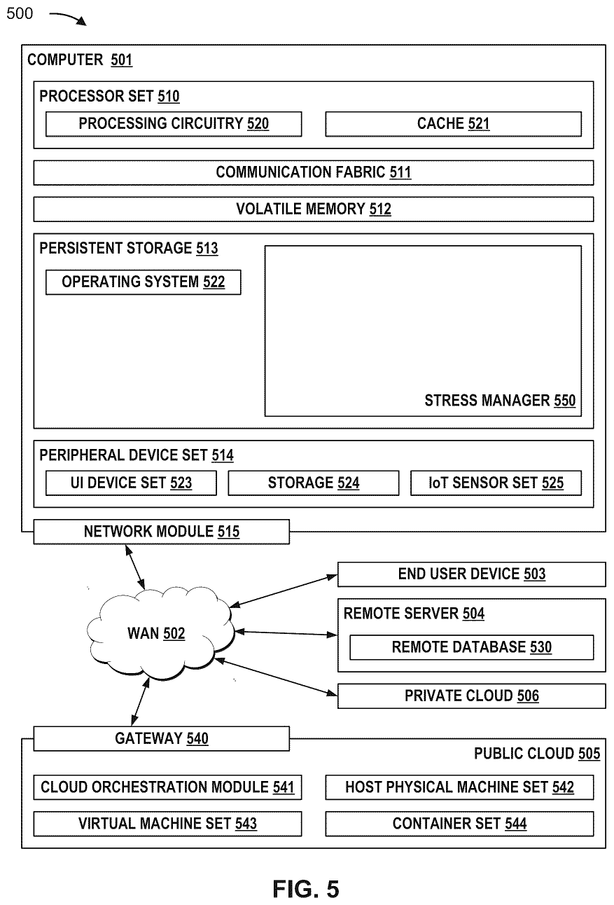

FIG. 5 is a diagram of an example computing environment 500 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code involved in performing the inventive methods, such as code for implementing a stress manager (e.g., the stress manager 112 shown in FIG. 1), shown in block 550. In addition to block 550, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 550, as identified above), peripheral device set 514 (including user interface (UI) device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. In some implementations, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in block 550 in persistent storage 513.

COMMUNICATION FABRIC 511 is the signal conduction path that allows the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, volatile memory 512 is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface-type operating systems that employ a kernel. The code included in block 550 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN 502 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501) and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

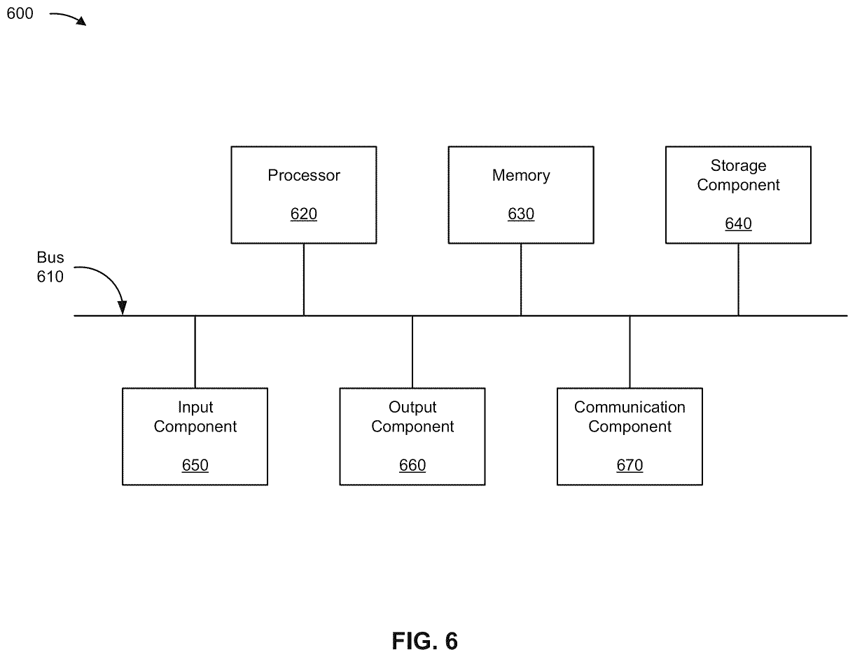

FIG. 6 is a diagram of example components of a device 600, which may implement one or more components of the computing environment 100. As shown in FIG. 6, device 600 may include a bus 610, a processor 620, a memory 630, a storage component 640, an input component 650, an output component 660, and a communication component 670.

Bus 610 includes a component that enables wired and/or wireless communication among the components of device 600. Processor 620 includes a central processing unit, a graphics processing unit, a microprocessor, a controller, a microcontroller, a digital signal processor, a field-programmable gate array, an application-specific integrated circuit, and/or another type of processing component. Processor 620 is implemented in hardware, firmware, or a combination of hardware and software. In some implementations, processor 620 includes one or more processors capable of being programmed to perform a function. Memory 630 includes a random access memory, a read only memory, and/or another type of memory (e.g., a flash memory, a magnetic memory, and/or an optical memory).

Storage component 640 stores information and/or software related to the operation of device 600. For example, storage component 640 may include a hard disk drive, a magnetic disk drive, an optical disk drive, a solid state disk drive, a compact disc, a digital versatile disc, and/or another type of non-transitory computer-readable medium. Input component 650 enables device 600 to receive input, such as user input and/or sensed inputs. For example, input component 650 may include a touch screen, a keyboard, a keypad, a mouse, a button, a microphone, a switch, a sensor, a global positioning system component, an accelerometer, a gyroscope, and/or an actuator. Output component 660 enables device 600 to provide output, such as via a display, a speaker, and/or one or more light-emitting diodes. Communication component 670 enables device 600 to communicate with other devices, such as via a wired connection and/or a wireless connection. For example, communication component 670 may include a receiver, a transmitter, a transceiver, a modem, a network interface card, and/or an antenna.

Device 600 may perform one or more processes described herein. For example, a non-transitory computer-readable medium (e.g., memory 630 and/or storage component 640) may store a set of instructions (e.g., one or more instructions, code, software code, and/or program code) for execution by processor 620. Processor 620 may execute the set of instructions to perform one or more processes described herein. In some implementations, execution of the set of instructions, by one or more processors 620, causes the one or more processors 620 and/or the device 600 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 6 are provided as an example. Device 600 may include additional components, fewer components, different components, or differently arranged components than those shown in FIG. 6. Additionally, or alternatively, a set of components (e.g., one or more components) of device 600 may perform one or more functions described as being performed by another set of components of device 600.

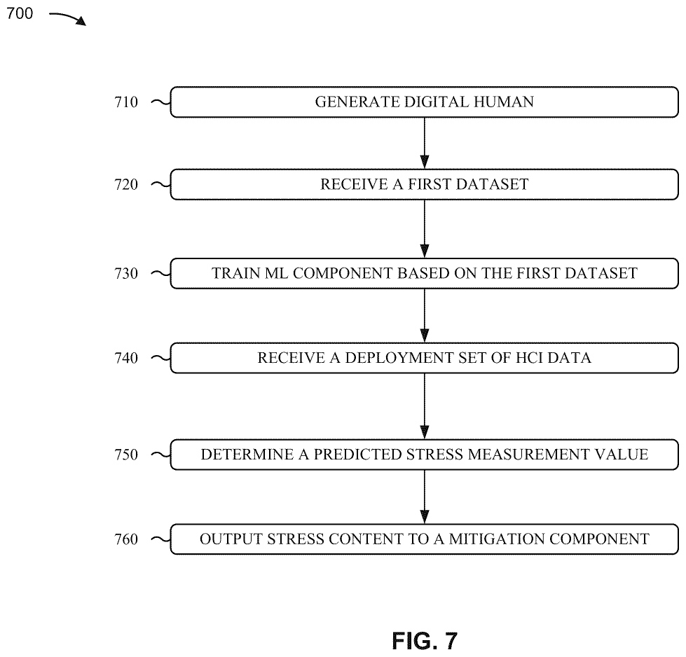

To further describe some implementations in greater detail, reference is next made to examples of processes which may be performed by or using the stress management system as described herein. FIG. 7 is a flowchart of an example of a process associated with determining and managing occupational stress. The process 700 can be executed using computing devices, such as the systems, hardware, and software described with respect to FIGS. 1-6. The process 700 can be performed, for example, by executing a machine-readable program or other computer-executable instructions, such as routines, instructions, programs, or other code. The steps, or operations, of the process 700, or another technique, method, process, or algorithm described in connection with the implementations disclosed herein can be implemented directly in hardware, firmware, software executed by hardware, circuitry, or a combination thereof.

For simplicity of explanation, the process 700 is depicted and described herein as a series of steps or operations. However, the steps or operations of the process 700 can occur in various orders and/or concurrently. Additionally, other steps or operations not presented and described herein may be used. Furthermore, not all illustrated steps or operations may be required to implement a process in accordance with the disclosed subject matter.

At 710, the process 700 includes generating a digital human corresponding to a user of a set of computing devices. For example, a stress manager (e.g., the stress manager 112 shown in FIG. 1) may create a digital representation of a user based on demographic information and baseline stress measurements. In some implementations, the digital human may include data on the user's typical keystroke patterns, mouse movements, and voice tone during both stressed and non-stressed states. The digital human may be represented as a set of data points or a mathematical model without a visual component. In Some implementations, the digital human may be visualized as an avatar that mimics the user's behaviors.

At 720, the process 700 includes receiving a first dataset associated with user interactions with the computing devices. For example, a computer interaction monitor (e.g., the computer interaction monitor 122 or 128 shown in FIG. 1) may collect HCl data such as keystroke dynamics, mouse movements, or application usage patterns. In some implementations, this step may also involve collecting data from biological monitors (e.g., the biological monitor 124 or 126 shown in FIG. 1) or behavior monitors (e.g., the behavior monitor 130 shown in FIG. 1). The first dataset may include historical data on user interactions, stress measurements, and project outcomes, collected over an extended period to account for natural variations in user behavior and stress levels.

At 730, the process 700 includes training a machine learning component based on the first dataset. For example, a training component (e.g., the training component 116 shown in FIG. 1) may employ various training techniques, such as supervised learning, unsupervised learning, or reinforcement learning, depending on the nature of the available data and the specific stress prediction tasks. In some implementations, the training process may involve determining a baseline stress profile for the user during non-stressful conditions, as well as stress profiles during various work-related activities. The machine learning component may be trained to recognize patterns indicative of stress in software development contexts.

At 740, the process 700 includes receiving a deployment set of HCl data. For example, one or more monitoring components (e.g., the computer interaction monitor 122 or 128, the biological monitor 124 or 126, or the behavior monitor 130 shown in FIG. 1) may collect real-time or recent data from users during their software development activities. This deployment set may include various stress parameters such as keystroke metrics, mouse movement metrics, voice tone metrics, or collaboration tool usage data. In some implementations, the deployment set may also include project-specific data such as project phases, user roles, or time periods associated with the software development project.

At 750, the process 700 includes determining a predicted stress measurement value based on the machine learning model and the deployment set of HCl data. For example, a machine learning component (e.g., the machine learning component 114 shown in FIG. 1) may analyze the deployment set of HCl data using the trained model to calculate a stress measurement. In some implementations, this step may involve using a stress weight generator engine to recalibrate weights for different stress parameters based on their observed correlation with overall stress levels. The predicted stress measurement value may be calculated as a weighted sum of various stress indicators, normalized against the user's baseline profile.

At 760, the process 700 includes outputting stress content indicative of the predicted stress measurement value to a mitigation component. For example, a stress manager (e.g., the stress manager 112 shown in FIG. 1) may send the calculated stress measurement and related data to a mitigation component (e.g., the mitigation component 118 shown in FIG. 1). In some implementations, the stress content may include not only the predicted stress measurement value but also information about specific stressors identified, correlations with project phases or roles, and any other relevant context that might inform stress mitigation strategies.

In some implementations, the process 700 may include additional steps or variations of the described steps. For example, the process 700 may include generating a mitigation plan based on the stress content. This mitigation plan may include recommendations for breaks, workload adjustments, or specific stress-reduction techniques tailored to the individual. In some implementations, the mitigation plan may be integrated with project management tools, automatically suggesting task reassignments or deadline adjustments based on the predicted stress levels.

The process 700 may also include steps for continuous monitoring and refinement of the stress prediction model. For instance, after implementing mitigation strategies, the process may loop back to step 740 to collect new HCl data, allowing for ongoing assessment of stress levels and the effectiveness of interventions. This iterative approach may enable the system to adapt to changing stress patterns and improve its predictions over time.

In some implementations, the process 700 may incorporate steps for team-level stress analysis in addition to individual assessments. For example, after determining individual stress measurements, the process may aggregate data across team members to identify team-wide stress patterns or potential issues affecting multiple individuals. This could inform higher-level project management decisions or team-wide wellness initiatives.

The process 700 may also include steps for forecasting future stress levels based on project timelines and historical data. For instance, the process 700 may use regression models to predict stress levels for upcoming project phases. This predictive capability could allow for proactive stress management, enabling project managers to adjust workloads or implement support measures before high-stress periods occur.

In some implementations, the process 700 may incorporate more advanced data collection methods. For example, step 720 might include collecting data from environmental sensors to account for workplace conditions that may influence stress levels. This could include factors such as noise levels, temperature fluctuations, or lighting conditions, providing a more comprehensive view of potential stressors in the software development environment.

According to an aspect of the disclosure, there is provided a computer system. The computer system includes a processor set, one or more computer-readable storage media, and program instructions stored on the one or more computer-readable storage media. The program instructions cause the processor set to perform operations. The operations include generating a digital human corresponding to a user of a set of computing devices. The digital human comprises a machine learning component corresponding to a stress profile associated with the user. The operations also include receiving a first dataset from at least one monitoring component associated with at least one of the set of computing devices or the user. The first dataset is associated with one or more user interactions with the set of computing devices. The operations further include training the machine learning component based on the first dataset. The machine learning component is trained to output a predicted stress measurement value associated with the user based on human computer interaction (HCl) data corresponding to an involvement of the user in a software development project. The operations also include receiving a second data set from one or more monitoring components of the at least one monitoring component. The second data set comprises a deployment set of parameter values of a set of corresponding stress parameters. The operations further include determining the predicted stress measurement value based on the machine learning model and the deployment set of parameter values. The operations also include outputting stress content indicative of the predicted stress measurement value to a mitigation component. This system has the technical effect of enabling non-invasive, continuous monitoring of occupational stress levels in software development environments. Additionally, the use of a digital human model allows for personalized stress assessment, improving the accuracy and relevance of stress predictions for individual users.

In embodiments, the computer system's operations further include determining the set of stress parameters based on an availability of data associated with the user. This feature has the technical effect of adaptively selecting relevant stress indicators based on available data sources, enhancing the system's flexibility and applicability across different work environments. Additionally, this approach optimizes data utilization, potentially reducing computational overhead by focusing on the most informative parameters.

In embodiments, training the machine learning component can include determining a baseline stress profile associated with the user based on a non-stress environment. Training can also include determining a stress profile associated with the user based on a stress environment. The predicted stress measurement value is based on a difference between a stress measurement and the baseline stress profile. This approach has the technical effect of establishing a personalized baseline for each user, allowing for more accurate detection of stress deviations. Additionally, this method accounts for individual differences in stress responses, potentially improving the sensitivity and specificity of stress detection.

In embodiments, training the machine learning component can include determining a set of stress parameter weights using a stress weight generator engine based on the first dataset. Each stress parameter weight corresponds to a respective stress parameter of the set of stress parameters. This feature has the technical effect of dynamically adjusting the importance of different stress indicators, potentially improving the accuracy of stress predictions. Additionally, this approach allows the system to adapt to changing stress patterns over time or across different project phases.

In embodiments, determining the set of stress parameter weights can include obtaining at least one set of historical parameter values associated with the user of the set of stress parameters. It can also include generating a first stress profile comprising a first profile vector based on the at least one historical set of parameter values. The process can further include obtaining a current set of parameter values associated with the user of the set of stress parameter values, and generating a second stress profile comprising a second profile vector based on the current set of parameter values. The process then determines a similarity between the first profile vector and the second profile vector. The set of stress parameter weights is based on this similarity. This approach has the technical effect of leveraging historical data to contextualize current stress measurements, potentially improving the accuracy of stress predictions. Additionally, this method allows for the detection of subtle changes in stress patterns over time.

In embodiments, the at least one set of historical parameter values can comprise a plurality of sets of historical parameter values. Determining the set of stress parameter weights can further include determining a set of similarity values. Each similarity value of the set of similarity values corresponds to a respective set of historical parameter values of the plurality of sets of historical parameter values. The process can also include determining a set of historical parameter values, of the plurality of sets of historical parameter values, corresponding to a highest similarity value of the set of similarity values. The process can then determine a weight vector comprising the set of stress parameter weights based on the set of historical parameter values. Each stress parameter weight of the set of stress parameter weights is indicative of an amount of influence that a corresponding stress parameter has on a total stress value. This approach has the technical effect of identifying the most relevant historical data for stress prediction, potentially improving the accuracy and relevance of stress assessments. Additionally, this method allows for a nuanced understanding of how different factors contribute to overall stress levels.

In embodiments, the computer system's operations can further include refining the weight vector based on a calibration associated with biological data associated with the user. This feature has the technical effect of incorporating physiological data to validate and improve the accuracy of HCl-based stress predictions. Additionally, this approach allows for a more holistic assessment of stress by combining behavioral and biological indicators.

In embodiments, the deployment set of parameter values can correspond to at least one project metric associated with the software development project. The at least one project metric can comprise at least one of a project phase, a project role associated with the user, or a time period. This feature has the technical effect of contextualizing stress measurements within the specific dynamics of software development projects. Additionally, this approach allows for the identification of stress patterns associated with particular project phases or roles, potentially informing targeted stress management strategies.

In embodiments, the computer system can further include using an additional machine learning component to determine one or more correlations between the at least one project metric and a stress category. This feature has the technical effect of uncovering complex relationships between project characteristics and stress levels. Additionally, this approach can provide insights for project management to optimize workflows and team structures for stress reduction.

In embodiments, the computer system's operations can further include using a forecasting model to predict at least one future stress measurement value based on the at least one project metric. This feature has the technical effect of enabling proactive stress management by anticipating high-stress periods in advance. Additionally, this approach can inform resource allocation and scheduling decisions to mitigate potential stress peaks.

According to an aspect of the disclosure, there is provided a computer-implemented method. The method includes generating a digital human corresponding to a user of a set of computing devices. The digital human comprises a machine learning component corresponding to a stress profile associated with the user. The method also includes receiving a first dataset from at least one monitoring component associated with at least one of the set of computing devices or the user. The first dataset is associated with one or more user interactions with the set of computing devices. The method further includes training the machine learning component based on the first dataset. The machine learning component is trained to output a predicted stress measurement value associated with the user based on human computer interaction (HCl) data corresponding to an involvement of the user in a software development project. The method also includes receiving a second dataset from one or more monitoring components of the at least one monitoring component. The second dataset comprises a deployment set of parameter values of a set of corresponding stress parameters. The method further includes determining the predicted stress measurement value based on the machine learning model and the deployment set of HCl data. The method also includes outputting stress content indicative of the predicted stress measurement value to a mitigation component. This method has the technical effect of providing a systematic approach to stress monitoring and management in software development environments. Additionally, the method enables continuous adaptation of stress prediction models to changing work patterns and individual stress responses.

In embodiments, the method can include receiving the stress content by the mitigation component. The method can also include generating a mitigation plan based on the stress content. The method can further include outputting mitigation plan content to cause a display device of a user device associated with the user to render a representation of the mitigation plan. This approach has the technical effect of translating stress measurements into actionable interventions. Additionally, this method provides a direct feedback loop to users, potentially improving engagement with stress management strategies.

In embodiments, the mitigation plan can comprise at least one of a recommended action, an updated role assignment associated with the user, a scheduling module for scheduling a health checkup, a team well-being initiative description, an indication of a team building activity, or an indication of suggested leave to be taken by the user. This feature has the technical effect of providing diverse and targeted stress management interventions. Additionally, this approach allows for a holistic approach to stress management, addressing both individual and team-level factors.

In embodiments, the stress content can be indicative of an activity that contributes to stress of the user. The method can further include generating a modified design of the activity to facilitate stress reduction. The mitigation plan content is indicative of the modified design. This approach has the technical effect of directly addressing sources of stress within the work environment. Additionally, this method enables continuous improvement of work processes to reduce stress over time.

In embodiments, the method can further include obtaining efficacy data associated with the mitigation plan. The method can also include generating a fine-tuned machine learning component by retraining the machine learning component based on the efficacy data. This feature has the technical effect of creating a feedback loop that improves the effectiveness of stress management interventions over time. Additionally, this approach allows the system to adapt to changing stress patterns and individual responses to interventions.

In embodiments, the stress content can be indicative of an activity that contributes to stress of the user. The method can further include determining a predicted time period during which the activity will occur based on a set of project data associated with the software development project. Outputting the mitigation plan content can comprise outputting the mitigation plan content at a predicted mitigation time based on the predicted time period. This approach has the technical effect of enabling proactive and timely stress management interventions. Additionally, this method aligns stress management efforts with project timelines, potentially improving their effectiveness and relevance.

According to an aspect of the disclosure, there is provided a computer program product. The computer program product includes one or more computer-readable storage media and program instructions stored on the one or more computer-readable storage media. The program instructions perform operations including generating a digital human corresponding to a user of a set of computing devices. The digital human comprises a machine learning component corresponding to a stress profile associated with the user. The operations also include receiving a first dataset from at least one monitoring component associated with at least one of the set of computing devices or the user. The first dataset is associated with one or more user interactions with the set of computing devices. The operations further include training the machine learning component based on the first dataset. The machine learning component is trained to output a predicted stress measurement value associated with the user based on human computer interaction (HCl) data corresponding to an involvement of the user in a software development project. The operations also include receiving a second dataset from one or more monitoring components of the at least one monitoring component. The second dataset comprises a deployment set of parameter values of a set of corresponding stress parameters. The operations further include determining the predicted stress measurement value based on the machine learning model and the deployment set of HCl data. The operations also include outputting stress content indicative of the predicted stress measurement value to a mitigation component. This computer program product has the technical effect of providing a software-based solution for stress monitoring and management in software development environments. Additionally, the product enables easy integration of stress management capabilities into existing software development tools and workflows.

In embodiments, training the machine learning component can include determining a baseline stress profile associated with the user based on a non-stress environment. Training can also include determining a stress profile associated with the user based on a stress environment. The predicted stress measurement is based on a difference between a stress measurement and the baseline stress profile. This approach has the technical effect of establishing personalized stress baselines, improving the accuracy of stress detection. Additionally, this method accounts for individual variations in stress responses, potentially enhancing the sensitivity of stress measurements.

In embodiments, the operations can further include determining the set of stress parameters associated with the set of HCl data based on an availability of data associated with the user. This feature has the technical effect of optimizing data utilization by focusing on available and relevant stress indicators. Additionally, this approach enhances the system's adaptability to different work environments and data collection capabilities.

In embodiments, the set of stress parameters can comprise at least one of: a time of day associated with the at least one of the set of computing devices or the user, a date associated with the at least one of the set of computing devices or the user, a location associated with the at least one of the set of computing devices or the user, a keystroke metric associated with the at least one of the set of computing devices or the user, a mouse movement metric associated with the at least one of the set of computing devices or the user, a haptic measurement metric associated with the at least one of the set of computing devices or the user, a facial expression metric associated with the user, a restlessness metric associated with the user, a voice tone metric associated with the user, an attendance metric associated with the user, a punctuality metric associated with the user, a participation metric associated with the user, a written communication metric associated with the user, a collaboration tool analysis associated with the user, a leave pattern metric associated with at least one of the user or an additional user, an attrition metric associated with at least one of the user or the additional user, a productivity metric associated with at least one of the user or the additional user, or a work quality metric associated with at least one of the user or the additional user. This comprehensive set of parameters has the technical effect of capturing a wide range of potential stress indicators. Additionally, this approach allows for a nuanced understanding of stress manifestations in various aspects of work and behavior.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer system comprising:
a processor set;
one or more computer-readable storage media; and
program instructions stored on the one or more computer-readable storage media to cause the processor set to perform operations comprising:
generating a digital human corresponding to a user of a set of computing devices, wherein the digital human comprises a machine learning component corresponding to a stress profile associated with the user;
receiving, from at least one monitoring component associated with at least one of the set of computing devices or the user, a first dataset associated with one or more user interactions with the set of computing devices;
training the machine learning component based on the first dataset, wherein the machine learning component is trained to output, based on human computer interaction (HCl) data corresponding to an involvement of the user in a software development project, a predicted stress measurement value associated with the user;
receiving, from one or more monitoring components of the at least one monitoring component, a second data set comprising a deployment set of parameter values of a set of corresponding stress parameters;
determining, based on the machine learning model and the deployment set of parameter values, the predicted stress measurement value; and
outputting, to a mitigation component, stress content indicative of the predicted stress measurement value.

2. The computer system of claim 1, the operations further comprising:
determining the set of stress parameters based on an availability of data associated with the user.

3. The computer system of claim 1, wherein training the machine learning component comprises:
determining, based on a non-stress environment, a baseline stress profile associated with the user; and
determining, based on a stress environment, a stress profile associated with the user, wherein the predicted stress measurement value is based on a difference between a stress measurement and the baseline stress profile.

4. The computer system of claim 1, wherein training the machine learning component comprises:
determining, using a stress weight generator engine and based on the first dataset, a set of stress parameter weights, wherein each stress parameter weight corresponds to a respective stress parameter of the set of stress parameters.

5. The computer system of claim 4, wherein determining the set of stress parameter weights comprises:
obtaining at least one set of historical parameter values, associated with the user, of the set of stress parameters;
generating, based on the at least one historical set of parameter values, a first stress profile comprising a first profile vector;
obtaining a current set of parameter values, associated with the user, of the set of stress parameter values;
generating, based on the current set of parameter values, a second stress profile comprising a second profile vector; and
determining a similarity between the first profile vector and the second profile vector, wherein the set of stress parameter weights is based on the similarity.

6. The computer system of claim 5, wherein the at least one set of historical parameter values comprises a plurality of sets of historical parameter values, and wherein determining the set of stress parameter weights further comprises:
determining a set of similarity values, wherein each similarity value of the set of similarity values corresponds to a respective set of historical parameter values of the plurality of sets of historical parameter values;
determining a set of historical parameter values, of the plurality of sets of historical parameter values, corresponding to a highest similarity value of the set of similarity values; and
determining, based on the set of historical parameter values, a weight vector comprising the set of stress parameter weights, wherein each stress parameter weight of the set of stress parameter weights is indicative of an amount of influence that a corresponding stress parameter has on a total stress value.

7. The computer system of claim 6, the operations further comprising refining the weight vector based on a calibration associated with biological data associated with the user.

8. The computer system of claim 1, wherein the deployment set of parameter values corresponds to at least one project metric associated with the software development project, the at least one project metric comprising at least one of a project phase, a project role associated with the user, or a time period.

9. The computer system of claim 8, further comprising using an additional machine learning component to determine one or more correlations between the at least one project metric and a stress category.

10. The computer system of claim 8, the operations further comprising using a forecasting model to predict at least one future stress measurement value based on the at least one project metric.

11. A computer-implemented method, comprising:
generating a digital human corresponding to a user of a set of computing devices, wherein the digital human comprises a machine learning component corresponding to a stress profile associated with the user;
receiving, from at least one monitoring component associated with at least one of the set of computing devices or the user, a first dataset associated with one or more user interactions with the set of computing devices;
training the machine learning component based on the first dataset, wherein the machine learning component is trained to output, based on human computer interaction (HCl) data corresponding to an involvement of the user in a software development project, a predicted stress measurement value associated with the user;
receiving, from one or more monitoring components of the at least one monitoring component, a second dataset comprising a deployment set of parameter values of a set of corresponding stress parameters;
determining, based on the machine learning model and the deployment set of HCl data, the predicted stress measurement value; and
outputting, to a mitigation component, stress content indicative of the predicted stress measurement value.

12. The computer-implemented method of claim 11, comprising:
receiving, by the mitigation component, the stress content;
generating, based on the stress content, a mitigation plan; and
outputting mitigation plan content to cause a display device of a user device associated with the user to render a representation of the mitigation plan.

13. The computer-implemented method of claim 12, wherein the mitigation plan comprises at least one of a recommended action, an updated role assignment associated with the user, a scheduling module for scheduling a health checkup, a team well-being initiative description, an indication of a team building activity, or an indication of suggested leave to be taken by the user.

14. The computer-implemented method of claim 12, wherein the stress content is indicative of an activity that contributes to stress of the user, the method further comprising generating a modified design of the activity to facilitate stress reduction, wherein the mitigation plan content is indicative of the modified design.

15. The computer-implemented method of claim 12, further comprising:
obtaining efficacy data associated with the mitigation plan; and
generating a fine-tuned machine learning component by retraining the machine learning component based on the efficacy data.

16. The computer-implemented method of claim 12, wherein the stress content is indicative of an activity that contributes to stress of the user, the method further comprising:
determining, based on a set of project data associated with the software development project, a predicted time period during which the activity will occur,
wherein outputting the mitigation plan content comprises outputting the mitigation plan content at a predicted mitigation time based on the predicted time period.

17. A computer program product comprising:
one or more computer-readable storage media; and
program instructions stored on the one or more computer-readable storage media to perform operations comprising:
generating a digital human corresponding to a user of a set of computing devices, wherein the digital human comprises a machine learning component corresponding to a stress profile associated with the user;
receiving, from at least one monitoring component associated with at least one of the set of computing devices or the user, a first dataset associated with one or more user interactions with the set of computing devices;
training the machine learning component based on the first dataset, wherein the machine learning component is trained to output, based on human computer interaction (HCl) data corresponding to an involvement of the user in a software development project, a predicted stress measurement value associated with the user;
receiving, from one or more monitoring components of the at least one monitoring component, a second dataset comprising a deployment set of parameter values of a set of corresponding stress parameters;
determining, based on the machine learning model and the deployment set of HCl data, the predicted stress measurement value; and
outputting, to a mitigation component, stress content indicative of the predicted stress measurement value.

18. The computer program product of claim 17, wherein training the machine learning component comprises:
determining, based on a non-stress environment, a baseline stress profile associated with the user; and
determining, based on a stress environment, a stress profile associated with the user, wherein the predicted stress measurement is based on a difference between a stress measurement and the baseline stress profile.

19. The computer program product of claim 17, the operations further comprising determining, based on an availability of data associated with the user, the set of stress parameters associated with the set of HCl data.

20. The computer program product of claim 19, the set of stress parameters comprising at least one of:
a time of day associated with the at least one of the set of computing devices or the user,
a date associated with the at least one of the set of computing devices or the user,
a location associated with the at least one of the set of computing devices or the user,
a keystroke metric associated with the at least one of the set of computing devices or the user,
a mouse movement metric associated with the at least one of the set of computing devices or the user,
a haptic measurement metric associated with the at least one of the set of computing devices or the user,
a facial expression metric associated with the user,
a restlessness metric associated with the user,
a voice tone metric associated with the user,
an attendance metric associated with the user,
a punctuality metric associated with the user,
a participation metric associated with the user,
a written communication metric associated with the user,
a collaboration tool analysis associated with the user,
a leave pattern metric associated with at least one of the user or an additional user,
an attrition metric associated with at least one of the user or the additional user,
a productivity metric associated with at least one of the user or the additional user, or
a work quality metric associated with at least one of the user or the additional user.
